(19) United States
(12) Patent Application Publication
(10) Pub. No.: US 2015/0373362 A1
(43) Pub. Date: Dec. 24, 2015

(54) DEBLOCKING FILTER DESIGN FOR INTRA BLOCK COPY

(71) Applicant: QUALCOMM Incorporated, San Diego, CA (US)

(72) Inventors: Chao Pang, San Diego, CA (US); Ying Chen, San Diego, CA (US); Joel Sole Rojals, San Diego, CA (US); Marta Karczewicz, San Diego, CA (US)

(21) Appl. No.: 14/743,722

(22) Filed: Jun. 18, 2015

Related U.S. Application Data
(60) Provisional application No. 62/014,631, filed on Jun. 19, 2014.

(51) Int. Cl. H04N 19/52; H04N 19/176; H04N 19/187; H04N 19/174; H04N 19/597; H04N 19/172; H04N 19/117

(52) U.S. Cl. CPC H04N 19/52; H04N 19/172; H04N 19/176; H04N 19/117; H04N 19/174; H04N 19/597; H04N 19/187

(57) ABSTRACT

A video coding device may encode and/or decode video data. The video coding device encodes a first video block in a first picture by predicting values of the first video block based on a previously encoded video block in a second picture different than the first picture. The video coding device filters the first video block according to a deblocking filtering process. The video coding device encodes a second video block in the first picture by predicting values of the second video block based on a previously encoded video block in the first picture. The video coding device filters the second video block according to the deblocking filtering process. The video coding device decodes the first video block, filters the first video block according to the deblocking filtering process, decodes the second video block, and filters the second video block according to the deblocking filtering process.

This application claims the benefit of U.S. Provisional Application No. 62/014,631, filed Jun. 19, 2014, the entire content of which is incorporated herein by reference.

### TECHNICAL FIELD

This disclosure relates to video coding, and more particularly to filtering techniques for one or more video coding modes.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, and extensions of such standards, to transmit, receive and store digital video information more efficiently.

Video compression techniques include spatial prediction and/or temporal prediction to reduce or remove redundancy inherent in video sequences. For block-based video coding, a video picture or slice may be partitioned into blocks. Each block can be further partitioned. Blocks in an intra-coded (I) picture or slice are encoded using spatial prediction with respect to reference samples in neighboring blocks in the same picture or slice. Blocks in an inter-coded (P or B) picture or slice may use spatial prediction with respect to reference samples in neighboring blocks in the same picture or slice or temporal prediction with respect to reference samples in other reference pictures. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized.

### SUMMARY

In general, the disclosure describes techniques for coding video data using a deblocking filtering process. A video coding device may encode and/or decode the video data. In encoding the video data, the video coding device encodes a first video block in a first picture. In some examples, encoding the first video block includes predicting values of the first video block based on a previously encoded video block in a second picture, with the second picture being different than the first picture. The video coding device filters the first video block according to a deblocking filtering process. The video coding device also encodes a second video block in the first picture. In some examples, encoding the second video block includes predicting values of the second video block based on a previously encoded video block in the first picture. The video coding device filters the second video block according to the deblocking filtering process. The video coding device further decodes the first video block and filters the first video block according to the deblocking filtering process. The video coding device further decodes the second video block and filters the second video block according to the deblocking filtering process.

In one example, the disclosure is directed to a method of decoding video data, the method comprising: decoding a first video block in a first picture, wherein decoding the first video block includes predicting values of the first video block based on a previously decoded video block in a second picture, wherein the second picture is different than the first picture; filtering the first video block according to a deblocking filtering process; decoding a second video block in the first picture, wherein decoding the second video block includes predicting values of the second video block based on a previously decoded video block in the first picture; and filtering the second video block according to the deblocking filtering process.

In another example, the disclosure is directed to a device for decoding video data, the device comprising: a memory configured to store the video data; and one or more processors configured to: decode a first video block in a first picture, wherein decoding the first video block includes predicting values of the first video block based on a previously decoded video block in a second picture, wherein the second picture is different than the first picture; filter the first video block according to a deblocking filtering process; decode a second video block in the first picture, wherein decoding the second video block includes predicting values of the second video block based on a previously decoded video block in the first picture; and filter the second video block according to the deblocking filtering process.

In another example, the disclosure is directed to a device for decoding video data, the device comprising: means for decoding a first video block in a first picture, wherein decoding the first video block includes predicting values of the first video block based on a previously decoded video block in a second picture, wherein the second picture is different than the first picture; means for filtering the first video block according to a deblocking filtering process; means for decoding a second video block in the first picture, wherein decoding the second video block includes predicting values of the second video block based on a previously decoded video block in the first picture; and means for filtering the second video block according to the deblocking filtering process.

In another example, the disclosure is directed to a computer-readable storage medium encoded with instructions that, when executed, cause one or more processors to: decode a first video block in a first picture, wherein decoding the first video block includes predicting values of the first video block based on a previously decoded video block in a second picture, wherein the second picture is different than the first picture; filter the first video block according to a deblocking filtering process; decode a second video block in the first picture, wherein decoding the second video block includes predicting values of the second video block based on a previously decoded video block in the first picture; and filter the second video block according to the deblocking filtering process.

In another example, the disclosure is directed to a method of encoding video data, the method comprising: encoding a first video block in a first picture, wherein encoding the first video block includes predicting values of the first video block based on a previously encoded video block in a second picture, wherein the second picture is different than the first picture; filtering the first video block according to a deblocking filtering process; encoding a second video block in the first picture, wherein encoding the second video block includes predicting values of the second video block based on a previously encoded video block in the first picture; and filtering the second video block according to the deblocking filtering process.

In another example, the disclosure is directed to a device for encoding video data, the device comprising: a memory configured to store the video data; and one or more processors configured to: encode a first video block in a first picture, wherein encoding the first video block includes predicting values of the first video block based on a previously encoded video block in a second picture, wherein the second picture is different than the first picture; filter the first video block according to a deblocking filtering process; encode a second video block in the first picture, wherein encoding the second video block includes predicting values of the second video block based on a previously encoded video block in the first picture; and filter the second video block according to the deblocking filtering process.

In another example, the disclosure is directed to a device for encoding video data, the device comprising: means for encoding a first video block in a first picture, wherein encoding the first video block includes predicting values of the first video block based on a previously encoded video block in a second picture, wherein the second picture is different than the first picture; means for filtering the first video block according to a deblocking filtering process; means for encoding a second video block in the first picture, wherein encoding the second video block includes predicting values of the second video block based on a previously encoded video block in the first picture; and means for filtering the second video block according to the deblocking filtering process.

In another example, the disclosure is directed to a computer-readable storage medium encoded with instructions that, when executed, cause one or more processors to: encode a first video block in a first picture, wherein encoding the first video block includes predicting values of the first video block based on a previously encoded video block in a second picture, wherein the second picture is different than the first picture; filter the first video block according to a deblocking filtering process; encode a second video block in the first picture, wherein encoding the second video block includes predicting values of the second video block based on a previously encoded video block in the first picture; and filter the second video block according to the deblocking filtering process.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a diagram illustrating one example of spatial neighboring motion vector (MV) candidates for merge mode and advanced motion vector prediction (AMVP) mode.

FIG. 2 is a diagram illustrating an example of an intra block copying process.

FIG. 3 is a block diagram illustrating an example video encoding and decoding system that may implement the techniques of this disclosure.

FIG. 4 is a block diagram illustrating an example video encoder that may implement the techniques of this disclosure.

FIG. 5 is a block diagram illustrating an example video decoder that may implement the techniques of this disclosure.

FIG. 6 is an illustration of a four-pixel long vertical block boundary formed by the adjacent blocks P and Q.

FIG. 7 is a flowchart illustrating an encoding technique according to one or more techniques of the current disclosure.

FIG. 8 is a flowchart illustrating a decoding technique according to one or more techniques of the current disclosure.

FIG. 9 is a flowchart illustrating an encoding technique according to one or more techniques of the current disclosure.

FIG. 10 is a flowchart illustrating a decoding technique according to one or more techniques of the current disclosure.

### DETAILED DESCRIPTION

This disclosure describes a deblocking filter design for coding modes that predict values of video blocks based on previously coded video blocks within the same picture. This disclosure describes methods to enable improved effect of deblocking when Intra Block Copy mode is enabled for screen content coding. The proposed methods are mainly concerned on screen content coding, but may be applicable to other settings. The techniques may also be useful in other modes, such as Inter Block Copy modes or other types of block copy modes.

In many examples, if a video block predicts values based on previously coded video blocks within the same picture, regardless of the way in which it does so, the deblocking filtering process is the same. However, using the same deblocking filtering process for each of these blocks may be inefficient and produce low-quality, blocky results. In some coding modes, such as a coding mode that includes determining a block vector predictor that uses integer block compensation, the characteristics of the video block may more similar to a video block that predicts values based on a video block in a second picture different than the picture the video block is located in (i.e., an inter mode) than a regular intra coded block in the same picture. Therefore, by using the same deblocking filtering process for blocks coded in an inter mode and blocks coded using a block vector predictor that uses integer block compensation and points to a video block within the same picture as the block being coded, a video coding device may remove blocky artifacts along block boundaries that occur when an intra mode deblocking filtering process is used. The above techniques also limit change that must occur within typical procedures.

In accordance with one or more techniques of the current disclosure, a video coding device may encode and/or decode video data. In encoding the video data, the video coding device encodes a first video block in a first picture. In some examples, encoding the first video block includes predicting values of the first video block based on a previously encoded video block in a second picture, with the second picture being different than the first picture. The video coding device filters the first video block according to a deblocking filtering process. The video coding device also encodes a second video block in the first picture. In some examples, encoding the second video block includes predicting values of the second video block based on a previously encoded video block in the first picture. The video coding device filters the second video block according to the deblocking filtering process. In decoding the video data, the video coding device further decodes the first video block and filters the first video block according to the deblocking filtering process. The video coding device further decodes the video data by decoding the second video block and filtering the second video block according to the deblocking filtering process.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. The design of a new video coding standard, namely High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). The latest HEVC draft specification shall be referred to as HEVC WD hereinafter. The Range Extensions to HEVC, namely HEVC RExt, are also being developed by the JCT-VC. A recent Working Draft (WD) of Range extensions shall be referred to as RExt WD7 hereinafter.

In this document, the HEVC specification text as in JCTVC-Q1003 is often referred to as HEVC version 1. The range extension specification may become the version 2 of the HEVC. However, to a large extent, as far as the proposed techniques are concerned, e.g., motion vector prediction, the HEVC version 1 and the range extension specification are technically similar. Therefore, whenever this document refers to the changes based on HEVC version 1, the same changes may also apply to the range extension specification, and whenever this document indicates the reuse the HEVC version 1 module, this document also contemplates reusing the HEVC range extension module (with the same sub-clauses).

For each block of video data, a set of motion information can be available. A set of motion information contains motion information for forward and backward prediction directions. Forward and backward prediction directions are two prediction directions of a bi-directional prediction mode and the terms “forward” and “backward” do not necessarily have a geometric meaning. Instead, the terms “forward” and “backward” correspond to reference picture list 0 (RefPicList0) and reference picture list 1 (RefPicList1) of a current picture. When only one reference picture list is available for a picture or slice, only RefPicList0 may be available and the motion information of each block of a slice may be forward.

For each prediction direction, the motion information may contain a reference index and a motion vector. In some cases, for simplicity, a motion vector itself may be referred in a way that it is assumed that it has an associated reference index. A reference index is used to identify a reference picture in the current reference picture list (RefPicList0 or RefPicList1). A motion vector has a horizontal and a vertical component.

Picture order count (POC) is widely used in video coding standards to identify a display order of a picture. Although some examples comprise two pictures within one coded video sequence which may have the same POC value, this scenario typically does not occur within a coded video sequence. When multiple coded video sequences are present in a bitstream, pictures with a same POC value may be closer to each other in a decoding order. POC values of pictures are typically used for reference picture list construction, derivation of reference picture set as in HEVC and motion vector scaling.

In HEVC, the largest coding unit in a slice is called a coding tree block (CTB). A CTB contains a quad-tree, the nodes of which are coding units. The size of a CTB can range from 16×16 to 64×64 in the HEVC main profile (although 8×8 CTB sizes can be supported). A coding unit (CU) may be the same size of a CTB although and as small as 8×8. Each coding unit is coded with one mode. When a CU is inter coded, it may be further partitioned into two prediction units (PUs), or become just one PU when further partition does not apply. When two PUs are present in one CU, they can be half size rectangles or two rectangle size with ¼ or ¾ size of the CU.

When the CU is inter coded, one set of motion information may be present for each PU. In addition, each PU may be coded with a unique inter-prediction mode to derive the set of motion information. In HEVC, the smallest PU sizes are 8×4 and 4×8, although other PU sizes may also be applicable to any modifications to HEVC, or to other video coding standards.

In HEVC, there may be at least two inter prediction modes. A first inter prediction mode is named merge mode (note that skip mode is considered to be a special case of merge). A second mode is named advanced motion vector prediction (AMVP) mode. In either AMVP or merge mode, a motion vector (MV) candidate list may be maintained for multiple motion vector predictors. The motion vector(s), as well as reference indices in the merge mode, of the current PU are generated by taking one candidate from the MV candidate list. Other inter modes may include directional prediction modes, such as uni-directional prediction (P mode) or bi-prediction (B mode).

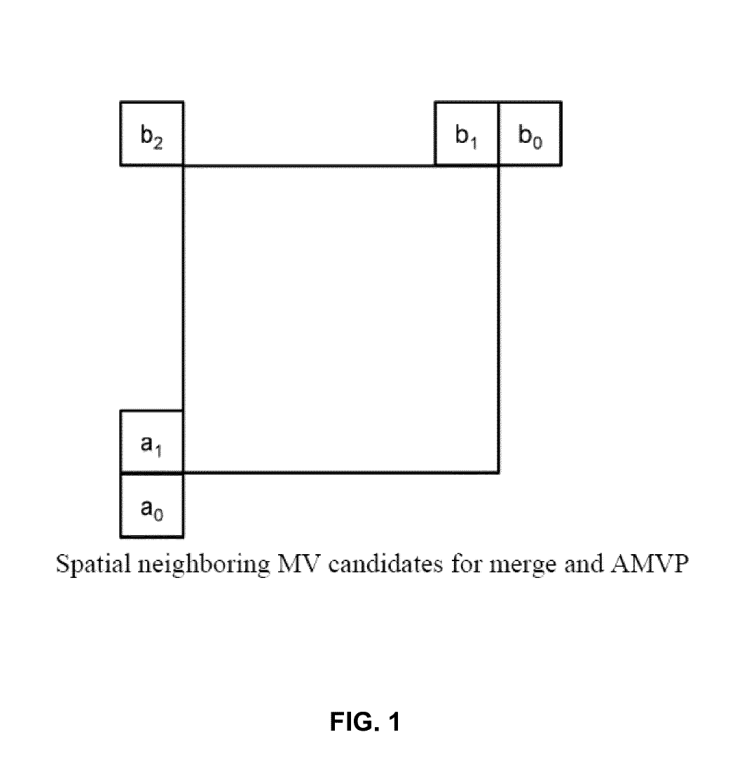

FIG. 1 is a diagram illustrating one example of spatial neighboring motion vector (MV) candidates for merge mode and advanced motion vector prediction (AMVP) mode. Spatial MV candidates are derived from the neighboring blocks shown in FIG. 1, for a specific PU (PU₀), although the methods generating the candidates from the blocks differ for merge and AMVP modes. In merge mode, an example of positions of five spatial MV candidates is shown in FIG. 1. At each candidate position, the availability may be checked according to the order: {a₁, b₁, b₀, a₀, b₂}.

In AMVP mode, the neighboring blocks are divided into two groups: left group consisting of the block a₀ and a₁, and above group consisting of the blocks b₀, b₁, and b₂ as shown in FIG. 1. For the left group, the availability is checked according to the order: {a₀, a₁}. For the above group, the availability is checked according to the order: {b₀, b₁, b₂}. For each group, the potential candidate in a neighboring block referring to the same reference picture as that indicated by the signaled reference index has the highest priority to be chosen to form a final candidate of the group. It is possible that not all neighboring blocks contain a motion vector pointing to the same reference picture. Therefore, if such a candidate cannot be found, the first available candidate may be scaled to form the final candidate, thus the temporal distance differences can be compensated.

The motion vector may be derived for the luma component of a current PU/CU. Before the motion vector is used for chroma motion compensation, the motion vector is scaled based on the chroma sampling format.

In HEVC, a largest coding unit (LCU) may be divided into parallel motion estimation regions (MERs). Further, LCUs allow only those neighboring PUs which belong to different MERs from the current PU to be included in the merge/skip MVP list construction process. The size of the MER is signaled in picture parameter set as log 2_parallel_merge_level_minus2. When MER size is larger than N×N, wherein 2N×2N is the smallest CU size, MER may take effect in a way that a spatial neighboring block, if it is inside the same MER as the current PU, is considered as unavailable.

In HEVC version 1, after picture reconstruction, the deblocking filter process detects the artifacts at the coded block boundaries and attenuates the block artifacts by applying a selected filter. Filtering decisions are made separately for each boundary of four-sample length that lies on the grid dividing the picture into blocks of 8×8 samples. Specifically, when performing deblocking process, the following three criteria must be true:
1) The block boundary is a prediction unit or transform unit boundary;
2) The boundary strength is greater than zero;
3) Variation of signal on both sides of a block boundary is below a specified threshold.

When certain additional conditions hold, a strong filter is applied on the block edge instead of the normal deblocking filter.

Table 1 below sets forth exemplary boundary strength (Bs) decision criteria.

TABLE 1
Definition of Bs Values for the Boundary Between Two Neighboring
Luma Blocks [1]

| ID | Conditions | Bs |
|---|---|---|
| 1 | At least one of the blocks is Intra | 2 |
| 2 | At least one of the blocks has non-zero coded residual | 1 |
| | coefficient and boundary is a transform boundary | |
| 3 | Absolute differences between corresponding spatial motion | 1 |
| | vector components of the two blocks are >=1 in units of integer | |
| | pixels | |
| 4 | Motion-compensated prediction for the two blocks refers to | 1 |
| | different reference pictures or the number of motion vectors is | |
| | different for the two blocks | |
| 5 | Otherwise | 0 |

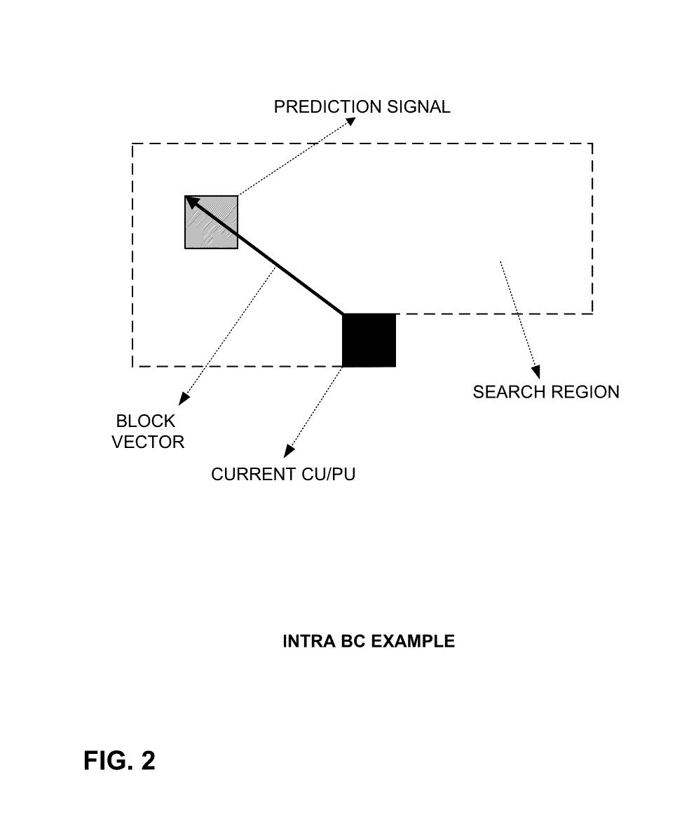

FIG. 2 is a diagram illustrating an example of an intra block copying process. The Intra Block Copy (BC) has been included in SCM. An example of Intra BC is shown as in FIG. 2, wherein the current CU/PU is predicted from an already decoded block of the current picture/slice. Note that prediction signal is reconstructed but without in-loop filtering, including de-blocking and Sample Adaptive Offset (SAO).

For the luma component or the chroma components that are coded with Intra BC, the block compensation is done with integer block compensation. Therefore, no interpolation may be required.

The block vector may be predicted and signalled in integer level. In accordance with SCM, the block vector predictor may be set to (−w, 0) at the beginning of each CTB, where w is the width of the CU. Such a block vector predictor is updated to be the one of the latest coded CU/PU if that is coded with Intra BC mode.

If a CU/PU is not coded with Intra BC, the block vector predictor keeps unchanged. After block vector prediction, the block vector difference is encoded using the motion vector difference coding method is HEVC.

The current Intra BC may be enabled at both CU and PU level. For PU level intra BC, 2N×N and N×2N PU partition is supported for all the CU sizes. In addition, when the CU is the smallest CU, N×N PU partition is supported. In one deblocking process consistent with the current SCM, the Intra BC block is treated as Intra.

There may exist particular problems may in current video coding techniques. Intra BC coded blocks may have different characteristics as Intra coded blocks. Thus, it may be more desirable to treat Intra BC mode as Inter mode during the deblocking process to avoid blocky artifact along block boundaries. When treating Intra BC blocks as Inter blocks in the deblocking process, a coder cannot directly reuse the deblocking process for Inter blocks as in Section 8.7.2 (e.g., HEVC sub-clause 8.7.2). While in video coding extensions, it is preferred to have minimum changes for the deblocking filter module.

Methods for deblocking filtering for blocks using a mode similar to an Intra BC mode are proposed in this disclosure to more efficiently reuse the deblocking process in HEVC. More specifically the following techniques are proposed. Each of the following techniques may apply separately or jointly with one or more of the others.

In some examples, a video coding device reuses the deblocking process (as in e.g. HEVC sub-clause 8.7.2) when Intra BC mode is enabled. The video coding device treats the Intra BC coded blocks as Inter blocks in the deblocking process in a way that the deblocking process in HEVC (version 1) does not need to be changed. After a current block is decoded, and before the deblocking process, if the current is coded as Intra BC, the current block's block type is converted to Inter (MODE_INTER). For example, if the current block (CU/PU) is purely coded with Intra BC, the video coding device sets the current block to be a uni-directionally predictive block from reference picture list X (with X being equal to 0 or alternatively 1). The block vector is considered to be the motion vector of the current block.

In some examples, when the video coding device treats the block with Intra BC mode Inter mode in the deblocking process, the video coding device sets the reference index to point to the current picture (e.g., the reference index is set to the value of the constant num_ref_idx_{—}1×_active_minus1+1). Alternatively, the video coding device may set any reference index (larger than or equal to 0) that is different from any reference index that corresponds to a normal reference picture (with a different POC value than that of the current picture) to the current block.

When Intra BC is jointly coded with normal Inter prediction for one block, the video coding device may convert the block vector and reference index similar as mentioned above. However, the video coding device may convert the reference index and the block vector to a reference index and motion vector, respectively, corresponding to the reference picture list Y if the motion vector of the current block contains a motion vector corresponding to reference picture list X (with X being equal to Y−1). In such an example, the current block is further considered as bi-directional predictive block.

In accordance with the above techniques of deblocking filtering, video encoder 20 may encode a first video block in a first picture. Encoding the first video block includes predicting values of the first video block based on a previously encoded video block in a second picture different than the first picture. Video encoder 20 may filter the first video block according to a deblocking filtering process. Video encoder 20 may further encode a second video block in the first picture. Encoding the second video block includes predicting values of the second video block based on a previously encoded video block in the first picture. In some examples, the previously encoded block in the first picture was encoded based on a previously encoded block in a third picture different than the first picture. Video encoder 20 may filter the second video block according to the deblocking filtering process.

In some examples, video encoder 20 may further set a reference index for the second video block to a value such that the reference index indicates that the second video block in the first picture is predicted based on the previously encoded video block in the first picture. In other examples, video encoder 20 may further determine a block vector. The block vector may comprise a motion vector between the second video block in the first picture and the previously encoded video block in the first picture.

In some examples, video encoder 20 may encode a third video block in the first picture. Encoding the third video block includes predicting values of the third video block based on a previously encoded video block in the first picture and a previously encoded video block in a third picture different than the first picture. In other words, the third video block may be a bi-directional predictive block. Video encoder 20 may further filter the third video block according to the deblocking filtering process.

Further, video decoder 30 may decode a first video block in a first picture. Encoding the first video block includes predicting values of the first video block based on a previously decoded video block in a second picture different than the first picture. Video decoder 30 may filter the first video block according to a deblocking filtering process. Video decoder 30 may further decode a second video block in the first picture. Encoding the second video block includes predicting values of the second video block based on a previously decoded video block in the first picture. In some examples, the previously decoded block in the first picture was decoded based on a previously decoded block in a third picture different than the first picture. Video decoder 30 may filter the second video block according to the deblocking filtering process.

In some examples, video decoder 30 may further set a reference index for the second video block to a value such that the reference index indicates that the second video block in the first picture is predicted based on the previously decoded video block in the first picture. In other examples, video decoder 30 may further determine a block vector. The block vector may comprise a motion vector between the second video block in the first picture and the previously decoded video block in the first picture.

In some examples, video decoder 30 may decode a third video block in the first picture. Encoding the third video block includes predicting values of the third video block based on a previously decoded video block in the first picture and a previously decoded video block in a third picture different than the first picture. In other words, the third video block may be a bi-directional predictive block. Video decoder 30 may further filter the third video block according to the deblocking filtering process.

During the deblocking process, whether the video coding device treats the Intra BC blocks as an inter block or an intra block depends on the coding mode of the pixels included in the reference block. In one example, when any of the pixels in the reference block is coded with Intra mode, the video coding device treats the Intra BC block as an intra block during the deblocking process. Otherwise, the video coding device treats the Intra BC block as an inter block during the deblocking process.

In other words, video encoder 20 may encode a third video block in the first picture. Encoding the third video block includes predicting values of the third video block in the first picture based on a second previously encoded video block in the first picture. The second previously encoded video block in the first picture was encoded based on a third previously encoded video block in the first picture and an Intra coding mode. In such an example, video encoder 20 may filter the third video block according to a second deblocking filtering process.

Further, video decoder 30 may decode a third video block in the first picture. Decoding the third video block includes predicting values of the third video block in the first picture based on a second previously decoded video block in the first picture. The second previously decoded video block in the first picture was decoded based on a third previously decoded video block in the first picture and an Intra coding mode. In such an example, video decoder 30 may filter the third video block according to a second deblocking filtering process.

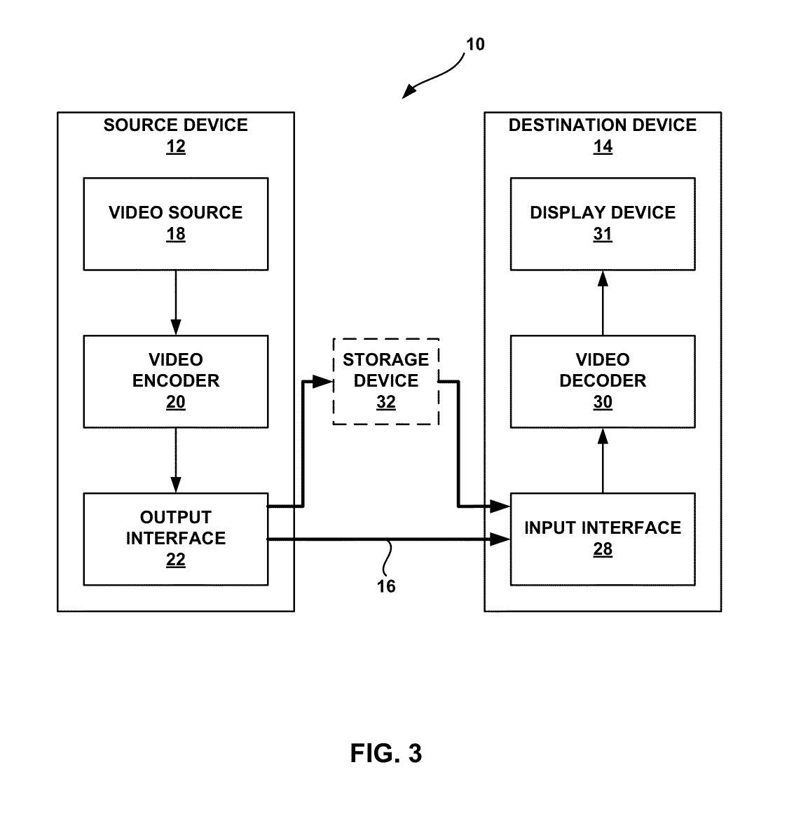

FIG. 3 is a block diagram illustrating an example video encoding and decoding system 10 that may implement the techniques of this disclosure. As shown in FIG. 3, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 of source device 12 to a storage device 32. Similarly, encoded data may be accessed from the storage device 32 by input interface 28 of destination device 14. The storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device 32 may correspond to a file server or another intermediate storage device that may store the encoded video generated by source device 12.

Destination device 14 may access stored video data from the storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 3, source device 12 includes video source 18, video encoder 20, and output interface 22. Destination device 14 includes input interface 28, video decoder 30, and display device 31. In accordance with this disclosure, video encoder 20 of source device 12 may be configured to apply the techniques for performing transformation in video coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 3 is merely one example. Techniques described in this disclosure may be performed by any digital video encoding and/or decoding device. Although generally the techniques of this disclosure are performed by a video encoding or decoding device, the techniques may also be performed by a video codec. Moreover, the techniques of this disclosure may also be performed by a device or element that does not necessarily perform a full encoding or decoding process. Source device 12 and destination device 14 are merely examples of coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16 or storage device 32. The information of computer-readable medium 16 or storage device 32 may include syntax information defined by video encoder 20, which is also used by video decoder 30, that includes syntax elements that describe characteristics and/or processing of blocks and other coded units, e.g., GOPs. Display device 31 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (codec). A device including video encoder 20 and/or video decoder 30 may comprise an integrated circuit, a microprocessor, and/or a wireless communication device, such as a cellular telephone.

Although not shown in FIG. 3, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage device 32) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Video encoder 20 and video decoder 30 may operate according to a video compression standard, such as the HEVC standard. While the techniques of this disclosure are not limited to any particular coding standard, the techniques may be relevant to the HEVC standard, and particularly to the extensions of the HEVC standard, such as the RExt extension or screen content coding. The HEVC standardization efforts are based on a model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-five intra-prediction encoding modes.

In general, the working model of the HM describes that a video picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive coding tree units (CTUs). Each of the CTUs may comprise a coding tree block of luma samples, two corresponding coding tree blocks of chroma samples, and syntax structures used to code the samples of the coding tree blocks. In a monochrome picture or a picture that have three separate color planes, a CTU may comprise a single coding tree block and syntax structures used to code the samples of the coding tree block.

A video picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that have three separate color planes, a CU may comprise a single coding block and syntax structures used to code the samples of the coding block. A coding block is an N×N block of samples.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. A prediction block may be a rectangular (i.e., square or non-square) block of samples on which the same prediction is applied. A PU of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples.

TUs may include coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU. A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that have three separate color planes, a TU may comprise a single transform block and syntax structures used to transform the transform block samples.

Following transformation, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan.

After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, picture-based syntax data, and group of pictures (GOP)-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

Video decoder 30, upon obtaining the coded video data, may perform a decoding pass generally reciprocal to the encoding pass described with respect to video encoder 20. For example, video decoder 30 may obtain an encoded video bitstream that represents video blocks of an encoded video slice and associated syntax elements from video encoder 20. Video decoder 30 may reconstruct the original, unencoded video sequence using the data contained in the bitstream.

In some examples of the techniques in accordance with this disclosure, a reference picture may be the same picture as the picture that contains the current block being encoded or decoded. As such, the motion vector may reference a previously encoded or decoded block in the current picture. In some examples, the current block is said to be encoded or decoded using an Intra BC mode. In other examples, although a reference index may indicate that the reference picture is the same picture as the picture that contains the current block being encoded or decoded, similar to an intra mode, the current block is said to be encoded or decoded using an inter mode. In these examples, since the current picture is referencing itself in the encoding process, similar to an intra mode, a previous coding device may use an intra mode deblocking filtering process in filtering the current block, similar to other blocks that reference themselves in the encoding or decoding process. However, even though the coding device utilizes a motion vector and a reference picture that reference the current picture, similar to an intra mode, the resulting defects are more akin to the defects present when a block is encoded or decoded using an inter mode (blocky artifacts along block boundaries) than when a block is encoded or decoded using an intra mode. As such, treating the current block as if it was encoded or decoded using an inter mode may provide more accurate and efficient deblocking filtering than if the current block was treated as if it was encoded or decoded using an intra mode.

Video encoder 20 and video decoder 30 may perform one or more techniques in accordance with the current disclosure. For instance, video encoder 20 may encode a first video block in a first picture. Encoding the first video block includes predicting values of the first video block based on a previously encoded video block in a second picture different than the first picture. Video encoder 20 may filter the first video block according to a deblocking filtering process. Video encoder 20 may further encode a second video block in the first picture. Encoding the second video block includes predicting values of the second video block based on a previously encoded video block in the first picture. In some examples, the previously encoded block in the first picture was encoded based on a previously encoded block in a third picture different than the first picture. Video encoder 20 may filter the second video block according to the deblocking filtering process.

Further, video decoder 30 may decode a first video block in a first picture. Encoding the first video block includes predicting values of the first video block based on a previously decoded video block in a second picture different than the first picture. Video decoder 30 may filter the first video block according to a deblocking filtering process. Video decoder 30 may further decode a second video block in the first picture. Encoding the second video block includes predicting values of the second video block based on a previously decoded video block in the first picture. In some examples, the previously decoded block in the first picture was decoded based on a previously decoded block in a third picture different than the first picture. Video decoder 30 may filter the second video block according to the deblocking filtering process.

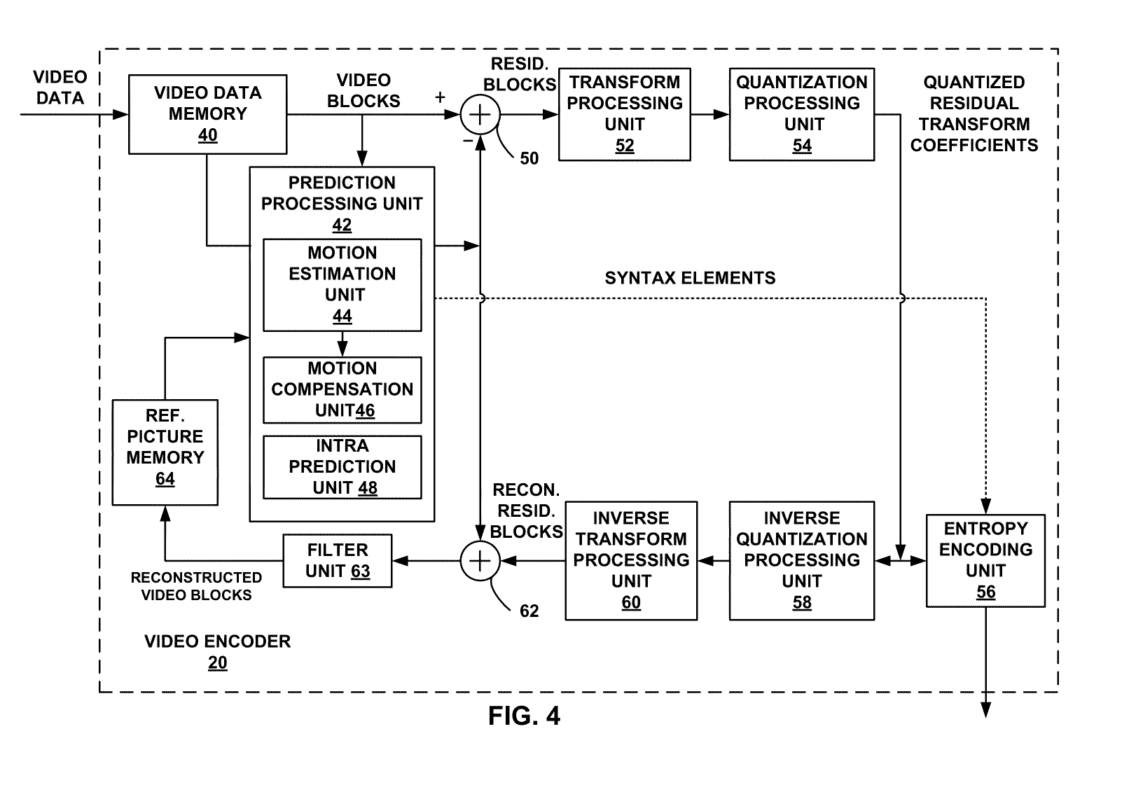

FIG. 4 is a block diagram illustrating an example of a video encoder 20 that may use techniques described in this disclosure. The video encoder 20 will be described in the context of HEVC coding for purposes of illustration, but without limitation of this disclosure as to other coding standards. Moreover, video encoder 20 may be configured to implement techniques in accordance with the range extensions or screen content coding.

Video encoder 20 may perform intra- and inter-coding of video blocks within video slices. Intra-coding relies on spatial prediction to reduce or remove spatial redundancy in video within a given video picture. Inter-coding relies on temporal prediction or inter-view prediction to reduce or remove temporal redundancy in video within adjacent pictures of a video sequence or reduce or remove redundancy with video in other views. Intra-mode (I mode) may refer to any of several spatial based compression modes. Inter-modes, such as uni-directional prediction (P mode) or bi-prediction (B mode), may refer to any of several temporal-based compression modes.

In the example of FIG. 4, video encoder 20 may include video data memory 40, prediction processing unit 42, reference picture memory 64, summer 50, transform processing unit 52, quantization processing unit 54, and entropy encoding unit 56. Prediction processing unit 42, in turn, includes motion estimation unit 44, motion compensation unit 46, and intra-prediction unit 48. For video block reconstruction, video encoder 20 also includes inverse quantization processing unit 58, inverse transform processing unit 60, and summer 62. A deblocking filter 63 may also be included to filter block boundaries to remove blockiness artifacts from reconstructed video. If desired, the deblocking filter would typically filter the output of summer 62. Additional loop filters (in loop or post loop) may also be used in addition to the deblocking filter. Sample adaptive offset (SAO) filtering may also be performed.

Video data memory 40 may store video data to be encoded by the components of video encoder 20. The video data stored in video data memory 40 may be obtained, for example, from video source 18. Reference picture memory 64 is one example of a decoding picture buffer (DPB) that stores reference video data for use in encoding video data by video encoder 20 (e.g., in intra- or inter-coding modes, also referred to as intra- or inter-prediction coding modes). Video data memory 40 and reference picture memory 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 40 and reference picture memory 64 may be provided by the same memory device or separate memory devices. In various examples, video data memory 40 may be on-chip with other components of video encoder 20, or off-chip relative to those components.

During the encoding process, video encoder 20 receives a video picture or slice to be coded. The picture or slice may be divided into multiple video blocks. Motion estimation unit 44 and motion compensation unit 46 perform inter-predictive coding of the received video block relative to one or more blocks in one or more reference pictures to provide temporal compression or provide inter-view compression. Intra-prediction unit 48 may alternatively perform intra-predictive coding of the received video block relative to one or more neighboring blocks in the same picture or slice as the block to be coded to provide spatial compression. Video encoder 20 may perform multiple coding passes (e.g., to select an appropriate coding mode for each block of video data).

Moreover, a partition unit (not shown) may partition blocks of video data into sub-blocks, based on evaluation of previous partitioning schemes in previous coding passes. For example, the partition unit may initially partition a picture or slice into LCUs, and partition each of the LCUs into sub-CUs based on rate-distortion analysis (e.g., rate-distortion optimization). Prediction processing unit 42 may further produce a quadtree data structure indicative of partitioning of an LCU into sub-CUs. Leaf-node CUs of the quadtree may include one or more PUs and one or more TUs.

Prediction processing unit 42 may select one of the coding modes, intra or inter, e.g., based on error results, and provides the resulting intra- or inter-coded block to summer 50 to generate residual block data and to summer 62 to reconstruct the encoded block for use as a reference picture. Prediction processing unit 42 also provides syntax elements, such as motion vectors, intra-mode indicators, partition information, and other such syntax information, to entropy encoding unit 56.

Motion estimation unit 44 and motion compensation unit 46 may be highly integrated, but are illustrated separately for conceptual purposes. Motion estimation, performed by motion estimation unit 44, is the process of generating motion vectors, which estimate motion for video blocks. A motion vector, for example, may indicate the displacement of a PU of a video block within a current video picture relative to a predictive block within a reference picture (or other coded unit) relative to the current block being coded within the current picture (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 44 may perform a motion search relative to the full pixel positions and fractional pixel positions and output a motion vector with fractional pixel precision.

Motion estimation unit 44 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 44 sends the calculated motion vector to entropy encoding unit 56 and motion compensation unit 46. In some examples, however, the reference picture may be the same picture as the picture that contains the current block being encoded. In such examples, the motion vector may reference a previously encoded block in the current picture.

Motion compensation, performed by motion compensation unit 46, may involve fetching or generating the predictive block based on the motion vector determined by motion estimation unit 44. Again, motion estimation unit 44 and motion compensation unit 46 may be functionally integrated, in some examples. Upon receiving the motion vector for the PU of the current video block, motion compensation unit 46 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 44 performs motion estimation relative to luma components, and motion compensation unit 46 uses motion vectors calculated based on the luma components for both chroma components and luma components. Prediction processing unit 42 may also generate syntax elements associated with the video blocks and the video slice for use by video decoder 30 in decoding the video blocks of the video slice.

Intra-prediction unit 48 may intra-predict a current block, as an alternative to the inter-prediction performed by motion estimation unit 44 and motion compensation unit 46, as described above. In particular, intra-prediction unit 48 may determine an intra-prediction mode to use to encode a current block. In some examples, intra-prediction unit 48 may encode a current block using various intra-prediction modes, e.g., during separate encoding passes, and intra-prediction unit 48 may select an appropriate intra-prediction mode to use from the tested modes.

For example, intra-prediction unit 48 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 48 may calculate ratios from the distortions and rates for the various encoded blocks to determine which intra-prediction mode exhibits the best rate-distortion value for the block.

Video encoder 20 forms a residual video block by subtracting the prediction data from prediction processing unit 42 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms may also be used. In any case, transform processing unit 52 applies the transform to the residual block, producing a block of residual transform coefficients. The transform may convert the residual information from a pixel value domain to a transform domain, such as a frequency domain.

Transform processing unit 52 may send the resulting transform coefficients to quantization processing unit 54. Quantization processing unit 54 quantizes the transform coefficients to further reduce bit rate. The quantization process may reduce the bit depth associated with some or all of the coefficients. The degree of quantization may be modified by adjusting a quantization parameter. In some examples, quantization processing unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization processing unit 58 and inverse transform processing unit 60 apply inverse quantization and inverse transformation, respectively, to reconstruct the residual block in the pixel domain, e.g., for later use as a reference block.

Motion compensation unit 46 may calculate a reference block by adding the residual block to a predictive block of one of the pictures of reference picture memory 64. Motion compensation unit 46 may also apply one or more interpolation filters to the reconstructed residual block to calculate sub-integer pixel values for use in motion estimation. Summer 62 adds the reconstructed residual block to the motion compensated prediction block produced by motion compensation unit 46 to produce a reconstructed video block for storage in reference picture memory 64. The reconstructed video block may be used by motion estimation unit 44 and motion compensation unit 46 as a reference block to inter-code a block in a subsequent video picture.

A filter unit 63 may perform a variety of filtering processes. For example, the filter unit 63 may perform deblocking. That is, the filter unit 63 may receive a plurality of reconstructed video blocks forming a slice or a frame of reconstructed video and filter block boundaries to remove blockiness artifacts from a slice or frame. In one example, filter unit 63 evaluates the so-called “boundary strength” of a video block. Based on the boundary strength of a video block, edge pixels of a video block may be filtered with respect to edge pixels of an adjacent video block such that the transition from one video block are more difficult for a viewer to perceive. In accordance with techniques of the current disclosure, as described below, filter unit 63 may perform deblocking filtering processes on the video data.

While a number of different aspects and examples of the techniques are described in this disclosure, the various aspects and examples of the techniques may be performed together or separately from one another. In other words, the techniques should not be limited strictly to the various aspects and examples described above, but may be used in combination or performed together and/or separately. In addition, while certain techniques may be ascribed to certain units of video encoder 20 (such as intra prediction unit 48, motion compensation unit 46, filter unit 63, or entropy encoding unit 56) it should be understood that one or more other units of video encoder 20 may also be responsible for carrying out such techniques.

As disclosed herein, video encoder 20 may be configured to implement one or more example techniques described in this disclosure. For instance, prediction processing unit 42 of video encoder 20 may encode a first video block in a first picture. Encoding the first video block includes predicting values of the first video block based on a previously encoded video block in a second picture different than the first picture. Filter unit 63 of video encoder 20 may filter the first video block according to a deblocking filtering process. Prediction processing unit 42 of video encoder 20 may further encode a second video block in the first picture. Encoding the second video block includes predicting values of the second video block based on a previously encoded video block in the first picture. In some examples, the previously encoded block in the first picture was encoded based on a previously encoded block in a third picture different than the first picture. Filter unit 63 of video encoder 20 may filter the second video block according to the deblocking filtering process.

As described above with respect to motion estimation unit 44 and motion compensation unit 46, in some examples of the techniques in accordance with this disclosure, a reference picture may be the same picture as the picture that contains the current block being encoded. As such, the motion vector may reference a previously encoded block in the current picture. In some examples, the current block is said to be encoded using an Intra BC mode. In other examples, although a reference index may indicate that the reference picture is the same picture as the picture that contains the current block being encoded, similar to an intra mode, the current block is said to be encoded using an inter mode. In these examples, since the current picture is referencing itself in the encoding process, similar to an intra mode, a previous encoder may use an intra mode deblocking filtering process in filtering the current block, similar to other blocks that reference themselves in the encoding process. However, even though the encoder utilizes a motion vector and a reference picture that reference the current picture, similar to an intra mode, the resulting defects are more akin to the defects present when a block is encoded using an inter mode (blocky artifacts along block boundaries) than when a block is encoded using an intra mode. As such, treating the current block as if it was encoded using an inter mode may provide more accurate and efficient deblocking filtering than if the current block was treated as if it was encoded using an intra mode.

In some examples, prediction processing unit 42 of video encoder 20 may further set a reference index for the second video block to a value such that the reference index indicates that the second video block in the first picture is predicted based on the previously encoded video block in the first picture. In other examples, prediction processing unit 42 of video encoder 20 may further determine a block vector. The block vector may comprise a motion vector between the second video block in the first picture and the previously encoded video block in the first picture.

In some examples, prediction processing unit 42 of video encoder 20 may encode a third video block in the first picture. Encoding the third video block includes predicting values of the third video block based on a previously encoded video block in the first picture and a previously encoded video block in a third picture different than the first picture. In other words, the third video block may be a bi-directional predictive block. Filter unit 63 of video encoder 20 may further filter the third video block according to the deblocking filtering process.

In some further examples, prediction processing unit 42 of video encoder 20 may encode a third video block in the first picture. Encoding the third video block includes predicting values of the third video block in the first picture based on a second previously encoded video block in the first picture. The second previously encoded video block in the first picture was encoded based on a third previously encoded video block in the first picture and an Intra coding mode. In such an example, filter unit 63 of video encoder 20 may filter the third video block according to a second deblocking filtering process.

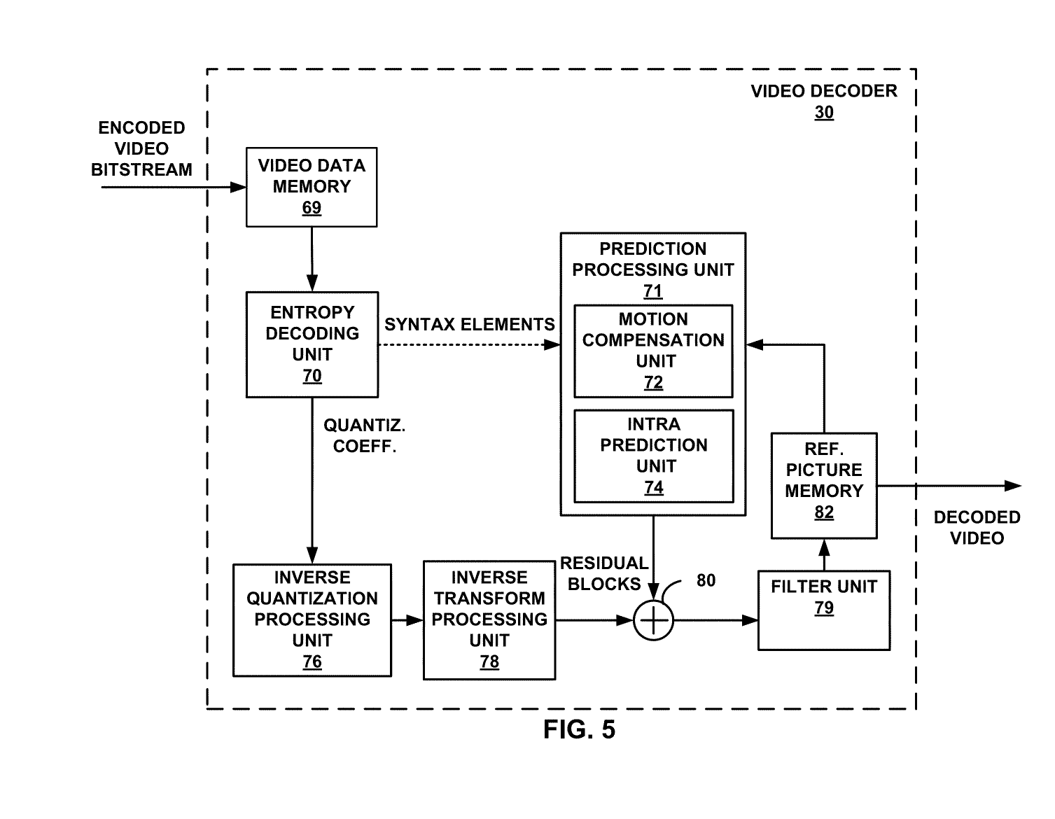

FIG. 5 is a block diagram illustrating an example of video decoder 30 that may implement techniques described in this disclosure. Again, the video decoder 30 will be described in the context of HEVC coding for purposes of illustration, but without limitation of this disclosure as to other coding standards. Moreover, video decoder 30 may be configured to implement techniques in accordance with the range extensions.

In the example of FIG. 5, video decoder 30 may include video data memory 69, entropy decoding unit 70, prediction processing unit 71, inverse quantization processing unit 76, inverse transform processing unit 78, summer 80, and reference picture memory 82. Prediction processing unit 71 includes motion compensation unit 72 and intra prediction unit 74. Video decoder 30 may, in some examples, perform a decoding pass generally reciprocal to the encoding pass described with respect to video encoder 20 from FIG. 2.

Video data memory 69 may store video data, such as an encoded video bitstream, to be decoded by the components of video decoder 30. The video data stored in video data memory 69 may be obtained, for example, from storage device 34, from a local video source, such as a camera, via wired or wireless network communication of video data, or by accessing physical data storage media. Video data memory 69 may form a coded picture buffer (CPB) that stores encoded video data from an encoded video bitstream.

Reference picture memory 82 is one example of a decoded picture buffer (DPB) that stores reference video data for use in decoding video data by video decoder 30 (e.g., in intra- or inter-coding modes). Video data memory 69 and reference picture memory 82 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 69 and reference picture memory 82 may be provided by the same memory device or separate memory devices. In various examples, video data memory 69 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current picture. When the video picture is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice. In some examples, however, the reference picture may be the same picture as the picture that contains the current block being encoded. In such examples, the motion vector may reference a previously encoded block in the current picture.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization processing unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform processing unit 78 applies an inverse transform, e.g., an inverse DCT, an inverse integer transform, or a conceptually similar inverse transform process, to the transform coefficients in order to produce residual blocks in the pixel domain. Video decoder 30 forms a decoded video block by summing the residual blocks from inverse transform processing unit 78 with the corresponding predictive blocks generated by motion compensation unit 72. Summer 80 represents the component or components that perform this summation operation.

Video decoder 30 may include a filter unit 79, which may, in some examples, be configured similarly to the filter unit 63 of video encoder 20 described above. For example, filter unit 79 may be configured to perform deblocking, SAO, or other filtering operations when decoding and reconstructing video data from an encoded bitstream.

While a number of different aspects and examples of the techniques are described in this disclosure, the various aspects and examples of the techniques may be performed together or separately from one another. In other words, the techniques should not be limited strictly to the various aspects and examples described above, but may be used in combination or performed together and/or separately. In addition, while certain techniques may be ascribed to certain units of video decoder 30 it should be understood that one or more other units of video decoder 30 may also be responsible for carrying out such techniques.

As described above with respect to motion compensation unit 72, in some examples of the techniques in accordance with this disclosure, a reference picture may be the same picture as the picture that contains the current block being decoded. As such, the motion vector may reference a previously decoded block in the current picture. In some examples, the current block is said to be decoded using an Intra BC mode. In other examples, although a reference index may indicate that the reference picture is the same picture as the picture that contains the current block being decoded, similar to an intra mode, the current block is said to be decoded using an inter mode. In these examples, since the current picture is referencing itself in the decoding process, similar to an intra mode, a previous decoder may use an intra mode deblocking filtering process in filtering the current block, similar to other blocks that reference themselves in the decoding process. However, even though the decoder utilizes a motion vector and a reference picture that reference the current picture, similar to an intra mode, the resulting defects are more akin to the defects present when a block is decoded using an inter mode (blocky artifacts along block boundaries) than when a block is decoded using an intra mode. As such, treating the current block as if it was decoded using an inter mode may provide more accurate and efficient deblocking filtering than if the current block was treated as if it was decoded using an intra mode.

In this way, video decoder 30 may be configured to implement one or more example techniques described in this disclosure. For instance, prediction processing unit 71 of video decoder 30 may decode a first video block in a first picture. Encoding the first video block includes predicting values of the first video block based on a previously decoded video block in a second picture different than the first picture. Filter unit 79 of video decoder 30 may filter the first video block according to a deblocking filtering process. Prediction processing unit 71 of video decoder 30 may further decode a second video block in the first picture. Encoding the second video block includes predicting values of the second video block based on a previously decoded video block in the first picture. In some examples, the previously decoded block in the first picture was decoded based on a previously decoded block in a third picture different than the first picture. Filter unit 79 of video decoder 30 may filter the second video block according to the deblocking filtering process.

In some examples, prediction processing unit 71 of video decoder 30 may further set a reference index for the second video block to a value such that the reference index indicates that the second video block in the first picture is predicted based on the previously decoded video block in the first picture. In other examples, prediction processing unit 71 of video decoder 30 may further determine a block vector. The block vector may comprise a motion vector between the second video block in the first picture and the previously decoded video block in the first picture.

In some examples, prediction processing unit 71 of video decoder 30 may decode a third video block in the first picture. Encoding the third video block includes predicting values of the third video block based on a previously decoded video block in the first picture and a previously decoded video block in a third picture different than the first picture. In other words, the third video block may be a bi-directional predictive block. Filter unit 79 of video decoder 30 may further filter the third video block according to the deblocking filtering process.

In some further examples, prediction processing unit 71 of video decoder 30 may decode a third video block in the first picture. Decoding the third video block includes predicting values of the third video block in the first picture based on a second previously decoded video block in the first picture. The second previously decoded video block in the first picture was decoded based on a third previously decoded video block in the first picture and an Intra coding mode. In such an example, filter unit 79 of video decoder 30 may filter the third video block according to a second deblocking filtering process.

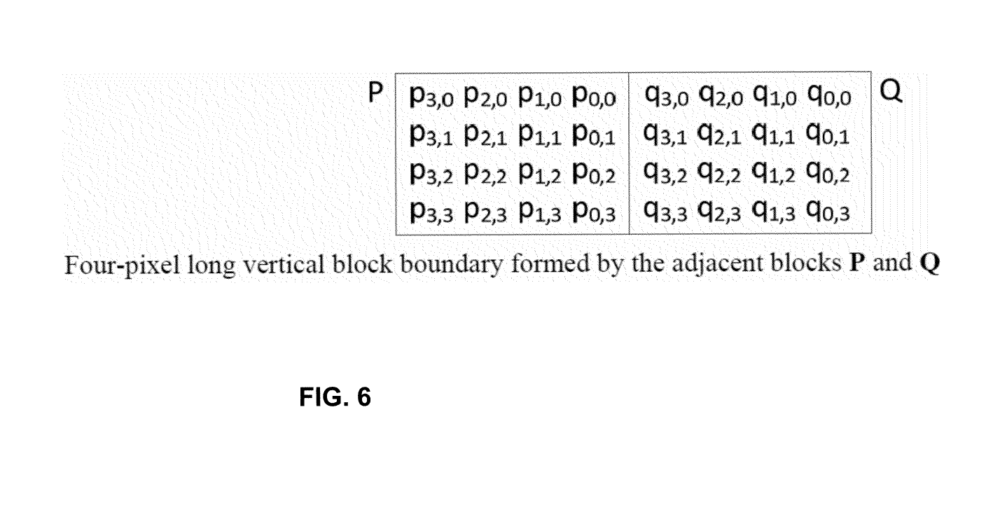

FIG. 6 is an illustration of a four-pixel long vertical block boundary formed by the adjacent blocks P and Q. When Bs is positive, the criteria to determine whether deblocking filter is enabled or not may be defined according to the following equation:

|p_{2.0}−2p_{1.0}+p_{0.0}|+|p_{2.3}−2p_{1.3}+p_{0.3}|+|q_{2.0}−2q_{1.0}+q_{0.0}|+|q_{2.3}=2q_{1.3}+q_{0.3}|<B (1)

The criteria to determine normal and strong deblocking filter is (i=0, 3):

|p_{2.1}=2p_{1.1}+p_{0.1}|+|q_{2.1}−2q_{1.1}+q_{0.1}|<B/8 (2)

|p_{3.1}−p_{0.1}|+|q_{3.1}−q_{0.1}|<B/8 (3)

|p_{0.1}−q_{0.1}|<2.5t_{c} (4)

Horizontal block boundary can be treated in a similar way. More details about the HEVC deblocking process can be found in HEVC WD Section 8.7.2.

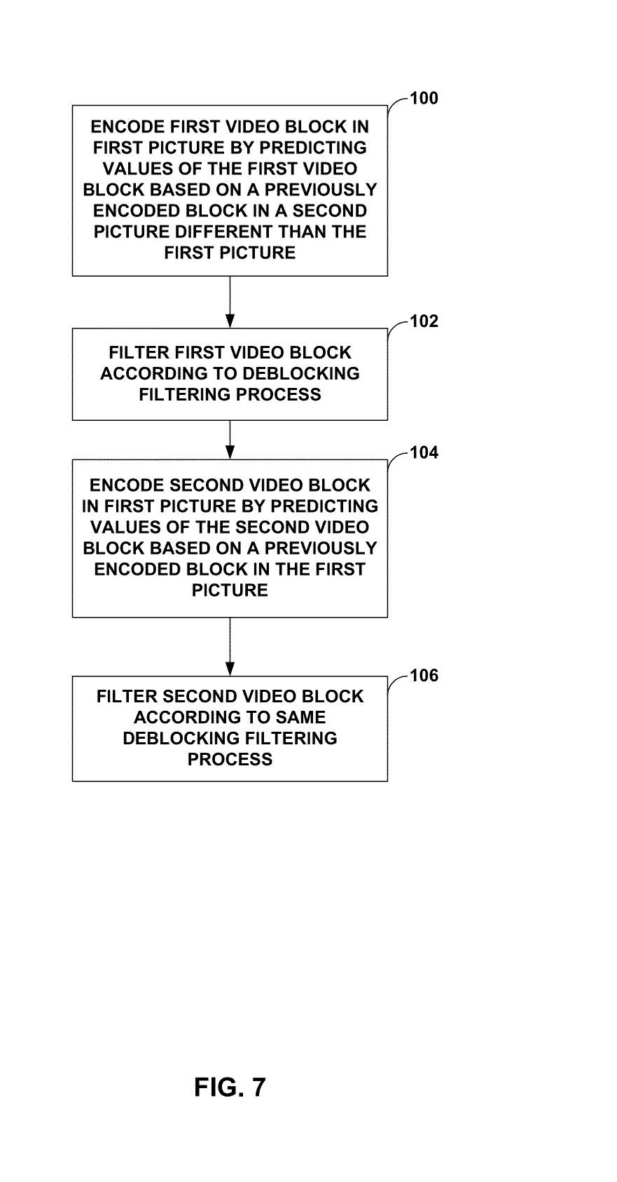

FIG. 7 is a flowchart illustrating an encoding technique according to one or more techniques of the current disclosure. As described above with respect to motion estimation unit 44 and motion compensation unit 46 of FIG. 4, in some examples of the techniques in accordance with this disclosure, a reference picture may be the same picture as the picture that contains the current block being encoded. As such, the motion vector may reference a previously encoded block in the current picture. In some examples, the current block is said to be encoded using an Intra BC mode. In other examples, although a reference index may indicate that the reference picture is the same picture as the picture that contains the current block being encoded, similar to an intra mode, the current block is said to be encoded using an inter mode. In these examples, since the current picture is referencing itself in the encoding process, similar to an intra mode, a previous encoder may use an intra mode deblocking filtering process in filtering the current block, similar to other blocks that reference themselves in the encoding process. However, even though the encoder utilizes a motion vector and a reference picture that reference the current picture, similar to an intra mode, the resulting defects are more akin to the defects present when a block is encoded using an inter mode (blocky artifacts along block boundaries) than when a block is encoded using an intra mode. As such, treating the current block as if it was encoded using an inter mode may provide more accurate and efficient deblocking filtering than if the current block was treated as if it was encoded using an intra mode.

As disclosed herein, a video encoder (e.g., video encoder 20 of FIG. 4) may be configured to implement one or more example techniques described in this disclosure. For instance, a component of video encoder 20 (e.g., prediction processing unit 42 of video encoder 20) may encode a first video block in a first picture (100). Encoding the first video block includes predicting values of the first video block based on a previously encoded video block in a second picture different than the first picture. A second component of video encoder 20 (e.g., filter unit 63 of video encoder 20) may filter the first video block according to a deblocking filtering process (102). Prediction processing unit 42 of video encoder 20 may further encode a second video block in the first picture (104). Encoding the second video block includes predicting values of the second video block based on a previously encoded video block in the first picture. In some examples, the previously encoded block in the first picture was encoded based on a previously encoded block in a third picture different than the first picture. Filter unit 63 of video encoder 20 may filter the second video block according to the deblocking filtering process (106).

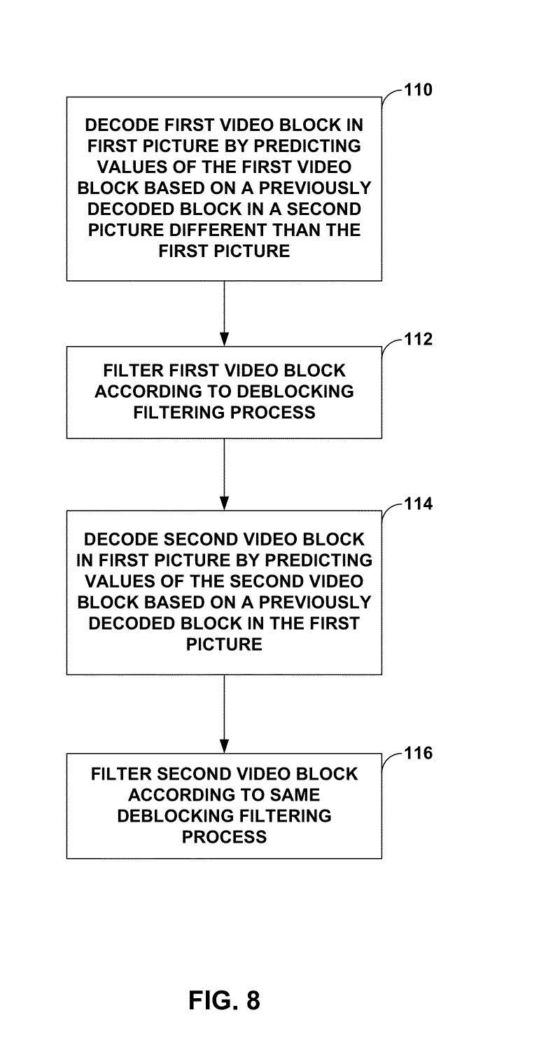

FIG. 8 is a flowchart illustrating a decoding technique according to one or more techniques of the current disclosure. As described above with respect to motion compensation unit 72 of FIG. 5, in some examples of the techniques in accordance with this disclosure, a reference picture may be the same picture as the picture that contains the current block being decoded. As such, the motion vector may reference a previously decoded block in the current picture. In some examples, the current block is said to be decoded using an Intra BC mode. In other examples, although a reference index may indicate that the reference picture is the same picture as the picture that contains the current block being decoded, similar to an intra mode, the current block is said to be decoded using an inter mode. In these examples, since the current picture is referencing itself in the decoding process, similar to an intra mode, a previous decoder may use an intra mode deblocking filtering process in filtering the current block, similar to other blocks that reference themselves in the decoding process. However, even though the decoder utilizes a motion vector and a reference picture that reference the current picture, similar to an intra mode, the resulting defects are more akin to the defects present when a block is decoded using an inter mode (blocky artifacts along block boundaries) than when a block is decoded using an intra mode. As such, treating the current block as if it was decoded using an inter mode may provide more accurate and efficient deblocking filtering than if the current block was treated as if it was decoded using an intra mode.

In this way, a video decoder (e.g., video decoder 30 of FIG. 5) may be configured to implement one or more example techniques described in this disclosure. For instance, a component of video decoder 30 (e.g., prediction processing unit 71 of video decoder 30) may decode a first video block in a first picture (110). Decoding the first video block includes predicting values of the first video block based on a previously decoded video block in a second picture different than the first picture. A second component of video decoder 30 (e.g., filter unit 79 of video decoder 30) may filter the first video block according to a deblocking filtering process (112). Prediction processing unit 71 of video decoder 30 may further decode a second video block in the first picture (114). Encoding the second video block includes predicting values of the second video block based on a previously decoded video block in the first picture. In some examples, the previously decoded block in the first picture was decoded based on a previously decoded block in a third picture different than the first picture. Filter unit 79 of video decoder 30 may filter the second video block according to the deblocking filtering process (116).

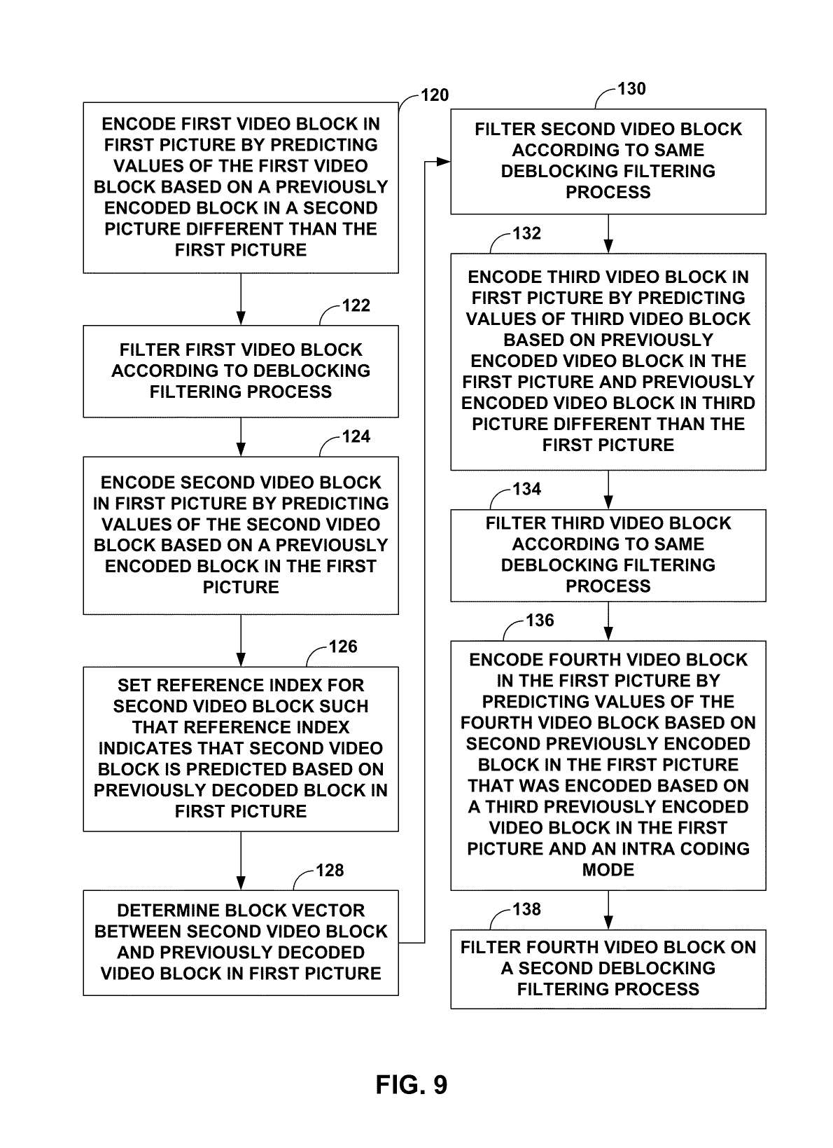

FIG. 9 is a flowchart illustrating an encoding technique according to one or more techniques of the current disclosure. As described above with respect to motion estimation unit 44 and motion compensation unit 46 of FIG. 4, in some examples of the techniques in accordance with this disclosure, a reference picture may be the same picture as the picture that contains the current block being encoded. As such, the motion vector may reference a previously encoded block in the current picture. In some examples, the current block is said to be encoded using an Intra BC mode. In other examples, although a reference index may indicate that the reference picture is the same picture as the picture that contains the current block being encoded, similar to an intra mode, the current block is said to be encoded using an inter mode. In these examples, since the current picture is referencing itself in the encoding process, similar to an intra mode, a previous encoder may use an intra mode deblocking filtering process in filtering the current block, similar to other blocks that reference themselves in the encoding process. However, even though the encoder utilizes a motion vector and a reference picture that reference the current picture, similar to an intra mode, the resulting defects are more akin to the defects present when a block is encoded using an inter mode (blocky artifacts along block boundaries) than when a block is encoded using an intra mode. As such, treating the current block as if it was encoded using an inter mode may provide more accurate and efficient deblocking filtering than if the current block was treated as if it was encoded using an intra mode.

As disclosed herein, a video encoder (e.g., video encoder 20 of FIG. 4) may be configured to implement one or more example techniques described in this disclosure. For instance, a component of video encoder 20 (e.g., prediction processing unit 42 of video encoder 20) may encode a first video block in a first picture (120). Encoding the first video block includes predicting values of the first video block based on a previously encoded video block in a second picture different than the first picture. A second component of video encoder 20 (e.g., filter unit 63 of video encoder 20) may filter the first video block according to a deblocking filtering process (122). Prediction processing unit 42 of video encoder 20 may further encode a second video block in the first picture (124). Encoding the second video block includes predicting values of the second video block based on a previously encoded video block in the first picture. In some examples, the previously encoded block in the first picture was encoded based on a previously encoded block in a third picture different than the first picture.

In some examples, prediction processing unit 42 of video encoder 20 may further set a reference index for the second video block to a value such that the reference index indicates that the second video block in the first picture is predicted based on the previously encoded video block in the first picture (126). In other examples, prediction processing unit 42 of video encoder 20 may further determine a block vector (128). The block vector may comprise a motion vector between the second video block in the first picture and the previously encoded video block in the first picture. Filter unit 63 of video encoder 20 may filter the second video block according to the deblocking filtering process (130).

In some examples, prediction processing unit 42 of video encoder 20 may encode a third video block in the first picture (132). Encoding the third video block includes predicting values of the third video block based on a previously encoded video block in the first picture and a previously encoded video block in a third picture different than the first picture. In other words, the third video block may be a bi-directional predictive block. Filter unit 63 of video encoder 20 may further filter the third video block according to the deblocking filtering process (134).

In some further examples, prediction processing unit 42 of video encoder 20 may encode a fourth video block in the first picture (136). Encoding the fourth video block includes predicting values of the fourth video block in the first picture based on a second previously encoded video block in the first picture. The second previously encoded video block in the first picture was encoded based on a third previously encoded video block in the first picture and an Intra coding mode. In such an example, filter unit 63 of video encoder 20 may filter the fourth video block according to a second deblocking filtering process (138).

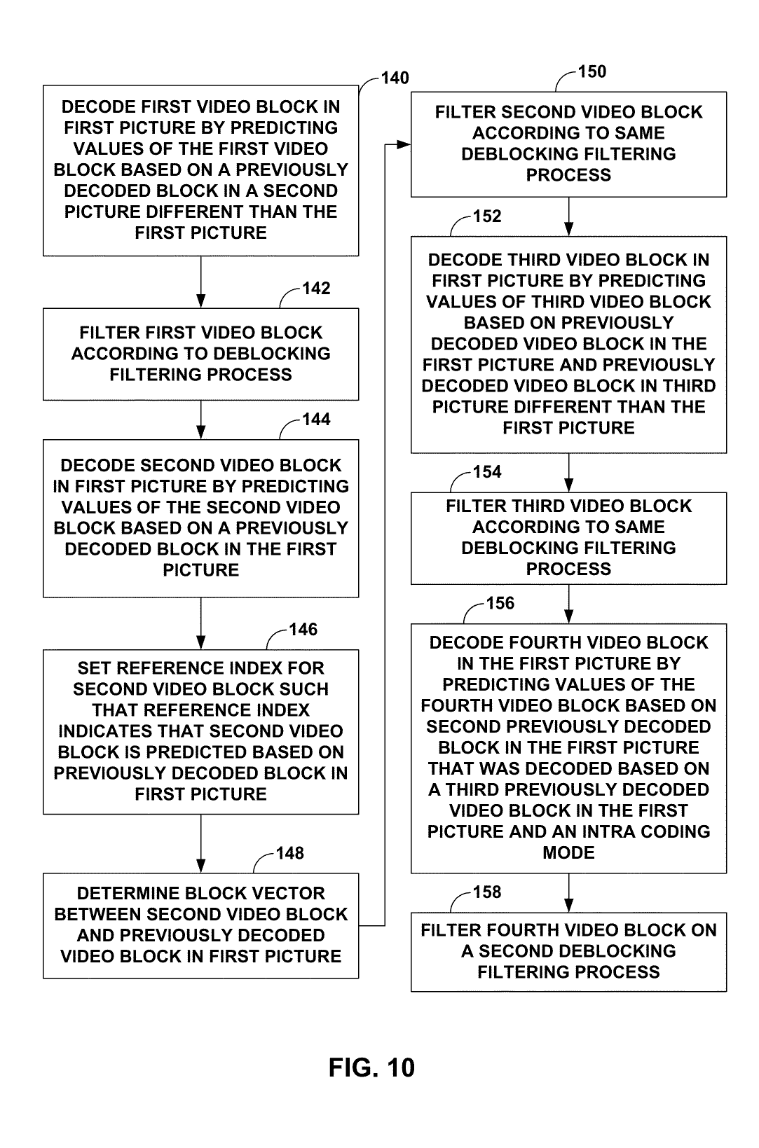

FIG. 10 is a flowchart illustrating a decoding technique according to one or more techniques of the current disclosure. As described above with respect to motion compensation unit 72 of FIG. 5, in some examples of the techniques in accordance with this disclosure, a reference picture may be the same picture as the picture that contains the current block being decoded. As such, the motion vector may reference a previously decoded block in the current picture. In some examples, the current block is said to be decoded using an Intra BC mode. In other examples, although a reference index may indicate that the reference picture is the same picture as the picture that contains the current block being decoded, similar to an intra mode, the current block is said to be decoded using an inter mode. In these examples, since the current picture is referencing itself in the decoding process, similar to an intra mode, a previous decoder may use an intra mode deblocking filtering process in filtering the current block, similar to other blocks that reference themselves in the decoding process. However, even though the decoder utilizes a motion vector and a reference picture that reference the current picture, similar to an intra mode, the resulting defects are more akin to the defects present when a block is decoded using an inter mode (blocky artifacts along block boundaries) than when a block is decoded using an intra mode. As such, treating the current block as if it was decoded using an inter mode may provide more accurate and efficient deblocking filtering than if the current block was treated as if it was decoded using an intra mode.

In this way, a video decoder (e.g., video decoder 30 of FIG. 5) may be configured to implement one or more example techniques described in this disclosure. For instance, a component of video decoder 30 (e.g., prediction processing unit 71 of video decoder 30) may decode a first video block in a first picture (140). Decoding the first video block includes predicting values of the first video block based on a previously decoded video block in a second picture different than the first picture. A second component of video decoder 30 (e.g., filter unit 79 of video decoder 30) may filter the first video block according to a deblocking filtering process (142). Prediction processing unit 71 of video decoder 30 may further decode a second video block in the first picture (144). Decoding the second video block includes predicting values of the second video block based on a previously decoded video block in the first picture. In some examples, the previously decoded block in the first picture was decoded based on a previously decoded block in a third picture different than the first picture.

In some examples, prediction processing unit 71 of video decoder 30 may further set a reference index for the second video block to a value such that the reference index indicates that the second video block in the first picture is predicted based on the previously decoded video block in the first picture (146). In other examples, prediction processing unit 71 of video decoder 30 may further determine a block vector (148). The block vector may comprise a motion vector between the second video block in the first picture and the previously decoded video block in the first picture. Filter unit 79 of video decoder 30 may filter the second video block according to the deblocking filtering process (150).

In some examples, prediction processing unit 71 of video decoder 30 may decode a third video block in the first picture (152). Decoding the third video block includes predicting values of the third video block based on a previously decoded video block in the first picture and a previously decoded video block in a third picture different than the first picture. In other words, the third video block may be a bi-directional predictive block. Filter unit 79 of video decoder 30 may further filter the third video block according to the deblocking filtering process (154).

In some further examples, prediction processing unit 71 of video decoder 30 may decode a fourth video block in the first picture (156). Decoding the fourth video block includes predicting values of the fourth video block in the first picture based on a second previously decoded video block in the first picture. The second previously decoded video block in the first picture was decoded based on a third previously decoded video block in the first picture and an Intra coding mode. In such an example, filter unit 79 of video decoder 30 may filter the fourth video block according to a second deblocking filtering process (158).

Below is an example implementation of the above techniques in HEVC. It should be noted that, while this is one implementation, other implementations may exist, such as when there is not an explicit mode for Intra BC. Instead, techniques of this disclosure may be implemented such that Intra BC mode is considered to be an inter mode with a reference index that indicates the current picture. This example supports Intra BC being treated as Inter block during the deblocking process. A syntax for the sequence parameter set RBSP may include:

| seq_parameter_set_rbsp( ) { | Descriptor |
|---|---|
| sps_video_parameter_set_id | u(4) |
| sps_max_sub_layers_minus1 | u(3) |
| sps_temporal_id_nesting_flag | u(1) |
| profile_tier_level( sps_max_sub_layers_minus1 ) | |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? | |
| 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_recorder_pics[ i ] | ue(v) |
| sps_max_latency_increase_plus1[ i ] | ue(v) |
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| scaling_list_enabled_flag | u(1) |
| if( scaling_list_enabled_flag ) { | |
| sps_scaling_list_data_present_flag | u(1) |
| if( sps_scaling_list_data_present_flag ) | |
| scaling_list_data( ) | |
| } | |
| amp_enabled_flag | u(1) |
| sample_adaptive_offset_enabled_flag | u(1) |
| pcm_enabled_flag | u(1) |
| if( pcm_enabled_flag ) { | |
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff_max_min_pcm_luma_coding_block_size | ue(v) |
| pcm_loop_filter_disabled_flag | u(1) |
| } | |
| num_short_term_ref_pic_sets | ue(v) |
| for( i = 0; i < num_short_term_ref_pic_sets; i++) | |
| short_term_ref_pic_set( i ) | |
| long_term_ref_pics_present_flag | u(1) |
| if( long_term_ref_pics_present_flag ) { | |
| num_long_term_ref_pics_sps | ue(v) |
| for( i = 0; i < num_long_term_ref_pics_sps; i++ ) { | |
| lt_ref_pic_poc_lsb_sps[ i ] | u(v) |
| used_by_curr_pic_lt_sps_flag[ i ] | u(1) |
| } | |
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |
| vui_parameters( ) | |
| sps_extension_present_flag | u(1) |
| if( sps_extension_present_flag ) { | |
| sps_range_extensions_flag | u(1) |
| sps_extension_7bits | u(7) |
| } | |
| if( sps_range_extensions_flag ) { | |
| transform_skip_rotation_enabled_flag | u(1) |
| transform_skip_context_enabled_flag | u(1) |
| implicit_rdpcm_enabled_flag | u(1) |
| explicit_rdpcm_enabled_flag | u(1) |
| extended_precision_processing_flag | u(1) |
| intra_smoothing_disabled_flag | u(1) |
| high_precision_offsets_enabled_flag | u(1) |
| fast_rice_adaptation_enabled_flag | u(1) |
| cabac_bypass_alignment_enabled_flag | u(1) |
| } | |
| if(sps_screen_content_coding_flag{ | |
| intra_block_copy_enable_flag | u(1) |
| } | |
| if( sps_extension_7bits ) | |
| while( more_rbsp_data( ) ) | |
| sps_extension_data_flag | u(1) |
| rbsp_trailing_bits( ) | |
| } | |

Further, a coding unit syntax may include:

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| if( intra_block_copy_enabled_flag ) | |
| intra_bc_flag[ x0 ][ y0 ] | ae(v) |
| if( slice_type != I && !intra_bc_flag[ x0 ][ y0 ] ) | |
| pred_mode_flag | ae(v) |
| if( CuPredMode[ x0 ][ y0 ] != MODE_INTRA \|\| intra_bc_flag[ x0 ][ y0 ] \|\| | |
| log2CbSize = = MinCbLog2SizeY ) | |
| part_mode | ae(v) |
| if( CuPredMode[ x0 ][ y0 ] = = MODE_INTRA ) { | |
| if( PartMode = = PART_2N×2N && pcm_enabled_flag && | |
| !intra_bc_flag[ x0 ][ y0 ] && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else if( intra_bc_flag[ x0 ][ y0 ] ) { | |
| mvd_coding( x0, y0, 2) | |
| if( PartMode = = PART_2N×N ) | |
| mvd_coding( x0, y0 + ( nCbS / 2 ), 2) | |
| else if( PartMode = = PART_N×2N ) | |
| mvd_coding( x0 + ( nCbS / 2 ), y0, 2) | |
| else if( PartMode = = PART_N×N ) { | |
| mvd_coding( x0 + ( nCbS / 2 ), y0, 2) | |
| mvd_coding( x0, y0 + ( nCbS / 2 ), 2) | |
| mvd_coding( x0 + ( nCbS / 2 ), y0 + ( nCbS / 2 ), 2) | |
| } | |
| } else { | |
| pbOffset = ( PartMode = = PART_N×N ) ? ( nCbS / 2 ) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] ) \|\| | |
| ( CuPredMode[ x0 ][ y0 ] = = MODE_INTRA && intra_bc_flag[ x0 ][ y0 ] ) | |
| ) | |
| rqt_root_cbf | ae(v) |
| if( rqt_root_cbf ) { | |
| MaxTrafoDepth = ( CuPredMode[ x0 ][ y0 ] = = MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

A prediction unit syntax for the above may include:

| prediction_unit( x0, y0, nPbW, nPbH ) { | Descriptor |
|---|---|
| if( cu_skip_flag[ x0 ][ y0 ] ) { | |
| if( MaxNumMergeCand > 1 ) | |
| merge_idx[ x0 ][ y0 ] | ae(v) |
| } else { /* MODE_INTER */ | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| if( slice_type = = B ) | |
| inter_pred_idc[ x0 ][ y0 ] | ae(v) |
| if( inter_pred_idc[ x0 ][ y0 ] != PRED_L1 ) { | |
| if( num_ref_idx_l0_active_minus1 > 0 ) | |
| ref_idx_l0[ x0 ][ y0 ] | ae(v) |
| mvd_coding( x0, y0, 0 ) | |
| mvp_l0_flag[ x0 ][ y0 ] | ae(v) |
| } | |
| if( inter_pred_idc[ x0 ][ y0 ] != PRED_L0 ) { | |
| if( num_ref_idx_l1_active_minus1 > 0 ) | |
| ref_idx_l1[ x0 ][ y0 ] | ae(v) |
| if( mvd_l1_zero_flag && | |
| inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| } else | |
| mvd_coding( x0, y0, 1 ) | |
| mvp_l1_flag[ x0 ][ y0 ] | ae(v) |
| } | |
| } | |
| } | |
| } | |

In the above syntax, the syntax element intra_block_copy_enabled_flag being equal to 1 specifies that intra block copy may be invoked in the decoding process for intra prediction. intra_block_copy_enabled_flag being equal to 0 specifies that intra block copy is not applied. When not present, the value of intra_block_copy_enabled_flag is inferred to be equal to 0.

When intra_bc_flag[x0][y0] is equal to 1, the current coding unit is coded in intra block copy mode. intra_bc_flag[x0][y0] being equal to 0 specifies that the current coding unit is coded according to pred_mode_flag. When not present, the value of intra_bc_flag is inferred to be equal to 1 if slice type is equal to I and cu_skip_flag is equal to 1. Otherwise, the value of intra_bc_flag is inferred to be equal to 0. The array indices x0, y0 specify the location (x0, y0) of the top-left luma sample of the considered coding block relative to the top-left luma sample of the picture.

The syntax element pred_mode_flag being equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1 if pred_mode_flag is equal to 0, CuPredMode[x][y] is set equal to MODE_INTER. Otherwise, (pred_mode_flag is equal to 1), CuPredMode[x][y] is set equal to MODE_INTRA.

When pred_mode_flag is not present, the variable CuPredMode[x][y] is derived as follows for x=x0 . . . x0+nCbS−1 and y=y0 . . . y0+nCbS−1. If intra_bc_flag[x0][y0] is equal to 1, CuPredMode[x][y] is inferred to be equal to MODE_INTRA. Otherwise, if slice_type is equal to I, CuPredMode[x][y] is inferred to be equal to MODE_INTRA. Otherwise (slice_type is equal to P or B), when cu_skip_flag[x0][y0] is equal to 1, CuPredMode[x][y] is inferred to be equal to MODE_SKIP.

The syntax element part_mode specifies partitioning mode of the current coding unit. The semantics of part_mode depend on CuPredMode[x0][y0]. The variables PartMode and IntraSplitFlag are derived from the value of part_mode as defined in Table 7-10. The value of part_mode is restricted as follows. If CuPredMode[x0][y0] is equal to MODE_INTRA, the following applies: If intra_bc_flag[x0][y0] is equal to 1, part_mode shall be in the range of 0 to 3, inclusive; otherwise, (intra_bc_flag[x0][y0] is equal to 0), part_mode shall be equal to 0 or 1. Otherwise (CuPredMode[x0][y0] is equal to MODE_INTER), the following applies: If log 2CbSize is greater than MinCbLog2SizeY and amp_enabled_flag is equal to 1, part_mode shall be in the range of 0 to 2, inclusive, or in the range of 4 to 7, inclusive; otherwise, if log 2CbSize is greater than MinCbLog2SizeY and amp_enabled_flag is equal to 0, or log 2CbSize is equal to 3, part_mode shall be in the range of 0 to 2, inclusive. Otherwise (log 2CbSize is greater than 3 and less than or equal to MinCbLog2SizeY), the value of part_mode shall be in the range of 0 to 3, inclusive.

When part_mode is not present, the variables PartMode and IntraSplitFlag are derived as follows: PartMode is set equal to PART_{—}2N×2N; IntraSplitFlag is set equal to 0.

Inputs to a general decoding process for coding unites coded in intra prediction mode are: a luma location (xCb, yCb) specifying the top-left sample of the current luma coding block relative to the top-left luma sample of the current picture; and a variable log 2CbSize specifying the size of the current luma coding block. Output of this process is a modified reconstructed picture before deblocking filtering.

The derivation process for quantization parameters as specified in subclause 8.6.1 is invoked with the luma location (xCb, yCb) as input. A variable nCbS is set equal to 1<<log 2CbSize. Depending on the values of pcm_flag[xCb][yCb] and IntraSplitFlag, the decoding process for luma samples is specified as follows: If pcm_flag[xCb][yCb] is equal to 1, the reconstructed picture is modified as follows:

S_{L}[xCb+i][yCb+j]=pcm_sample_luma[(nCbS*j)+i]<<(BitDepthγ−PcmBitDepthγ),with j=0 . . . nCbS−1 (8-12)

Otherwise (pcm_flag[xCb][yCb] is equal to 0), if IntraSplitFlag is equal to 0, the following ordered steps apply: 1. When intra_bc_flag[xCb][yCb] is equal to 0, the derivation process for the intra prediction mode as specified in subclause 8.4.2 is invoked with the luma location (xCb, yCb) as input. 2. When intra_bc_flag[xCb][yCb] is equal to 1, the derivation process for block vector components in intra block copying prediction mode as specified in subclause 8.4.4 is invoked with the luma location (xCb, yCb) and variable log 2CbSize as inputs, and the output being bvIntra. 3. The general decoding process for intra blocks as specified in subclause 8.4.4.1 is invoked with the luma location (xCb, yCb), the variable log 2TrafoSize set equal to log 2CbSize, the variable trafoDepth set equal to 0, the variable predModeIntra set equal to IntraPredModeY [xCb][yCb], the variable predModeIntraBc set equal to intra_bc_flag[xCb][yCb], the variable bvIntra set equal to Bvintra[xCb][yCb], and the variable cIdx set equal to 0 as inputs, and the output is a modified reconstructed picture before deblocking filtering.

Otherwise (pcm_flag[xCb][yCb] is equal to 0 and IntraSplitFlag is equal to 1), for the variable blkIdx proceeding over the values 0 . . . 3, the following ordered steps apply: 1. The variable xPb is set equal to xCb+(nCbS>>1)*(blkIdx % 2). 2. The variable yPb is set equal to yCb+(nCbS>>1)*(blkIdx/2). 3. The derivation process for the intra prediction mode as specified in subclause 8.4.2. is invoked with the luma location (xPb, yPb) as input. 4. The general decoding process for intra blocks as specified in subclause 8.4.4.1 is invoked with the luma location (xPb, yPb), the variable log 2TrafoSize set equal to log 2CbSize−1, the variable trafoDepth set equal to 1, the variable predModeIntra set equal to IntraPredModeY[xPb][yPb], the variable predModeIntraBc set equal to intra_bc_flag[xCb][yCb], the variable bvIntra set equal to Bvintra[xCb][yCb], and the variable cIdx set equal to 0 as inputs, and the output is a modified reconstructed picture before deblocking filtering.

When ChromaArrayType is not equal to 0, the variable log 2CbSizeC is set equal to log 2CbSize−(ChromaArrayType==3 ? 0:1). Depending on the value of pcm_flag[xCb][yCb] and IntraSplitFlag, the decoding process for chroma samples is specified as follows: If pcm_flag[xCb][yCb] is equal to 1, the reconstructed picture is modified as follows:

SCb[xCb/SubWidthC+i][yCb/SubHeightC+j]=pcm_sample_chroma[(nCbS/SubWidthC*j)+i]<<(BitDepthC−PcmBitDepthC),with i=0 . . . nCbS/SubWidthC−1, and j=0 . . . nS/SubHeightC−1 (8-13)

SCr[xCb/SubWidthC+i][yCb/SubHeightC+j]=pcm_sample_chroma[(nCbS/SubWidthC*(j+nCbS/SubHeightC))+i]<<(BitDepthC−PcmBitDepthC),with i=0 . . . nCbS/SubWidthC−1, and j=0 . . . nS/SubHeightC−1(8-14)

Otherwise (pcm_flag[xCb][yCb] is equal to 0), if IntraSplitFlag is equal to 0 or ChromaArrayType is not equal to 3, the following ordered steps apply: 1. When intra_bc_flag[xCb][yCb] is equal to 0, the derivation process for the chroma intra prediction mode as specified in 8.4.3 is invoked with the luma location (xCb, yCb) as input, and the output is the variable IntraPredModeC. 2. The general decoding process for intra blocks as specified in subclause 8.4.4.1 is invoked with the chroma location (xCb/SubWidthC, yCb/SubHeightC), the variable log 2TrafoSize set equal to log 2CbSizeC, the variable trafoDepth set equal to 0, the variable predModeIntra set equal to IntraPredModeC, the variable predModeIntraBc set equal to intra_bc_flag[xCb][yCb], the variable bvIntra set equal to Bvintra[xCb][yCb], and the variable cIdx set equal to 1 as inputs, and the output is a modified reconstructed picture before deblocking filtering. 3. The general decoding process for intra blocks as specified in subclause 8.4.4.1 is invoked with the chroma location (xCb/SubWidthC, yCb/SubHeightC), the variable log 2TrafoSize set equal to log 2CbSizeC, the variable trafoDepth set equal to 0, the variable predModeIntra set equal to IntraPredModeC, the variable predModeIntraBc set equal to intra_bc_flag[xCb][yCb], the variable bvIntra set equal to Bvintra[xCb][yCb], and the variable cIdx set equal to 2 as inputs, and the output is a modified reconstructed picture before deblocking filtering.

Otherwise (pcm_flag[xCb][yCb] is equal to 0, IntraSplitFlag is equal to 1 and ChromaArrayType is equal to 3), for the variable blkIdx proceeding over the values 0 . . . 3, the following ordered steps apply: 1. The variable xPb is set equal to xCb+(nCbS>>1)*(blkIdx % 2). 2. The variable yPb is set equal to yCb+(nCbS>>1)*(blkIdx/2). 3. The derivation process for the chroma intra prediction mode as specified in 8.4.3 is invoked with the luma location (xBS xPb, yBS yPb) as input, and the output is the variable IntraPredModeC. 4. The general decoding process for intra blocks as specified in subclause 8.4.5.1 is invoked with the chroma location (xPb, yPb), the variable log 2TrafoSize set equal to log 2CbSizeC−1, the variable trafoDepth set equal to 1, the variable predModeIntra set equal to IntraPredModeC, the variable predModeIntraBc set equal to intra_bc_flag[xCb][yCb], the variable bvIntra set equal to Bvintra[xCb][yCb], and the variable cIdx set equal to 1 as inputs, and the output is a modified reconstructed picture before deblocking filtering. 5. The general decoding process for intra blocks as specified in subclause 8.4.4.1 8.4.4.1 is invoked with the chroma location (xPb, yPb), the variable log 2TrafoSize set equal to log 2CbSizeC−1, the variable trafoDepth set equal to 1, the variable predModeIntra set equal to IntraPredModeC, the variable predModeIntraBc set equal to intra_bc_flag[xCb][yCb], the variable bvIntra set equal to Bvintra[xCb][yCb], and the variable cIdx set equal to 2 as inputs, and the output is a modified reconstructed picture before deblocking filtering.

Inputs to a derivation process for block vector components in intra block copy prediction mode are a luma location (xCb, yCb) of the top-left sample of the current luma coding block relative to the top-left luma sample of the current picture and a variable log 2CbSize specifying the size of the current luma coding block. Outputs of this derivation process include the (nCbS)x(nCbX) array of block vectors bvIntra, the luma motion vectors mvL0 and mvL1, the reference indices refIdxL0 and refIdxL1, and the prediction list utilization flags predFlagL0 and predFlagL1.

The variables nCbS, nCbSw, nCbSh are derived as follows:

nCbS=1<<log 2CbSize (8-25)

nPbSw=nCbS/(PartMode==PART_{—}2N×2N∥PartMode==PART_{—}2N×N?1:2) (8-25)

nPbSh=nCbS/(PartMode==PART_{—}2N×2N∥PartMode==PART_{—}N×2N?1:2) (8-25)

The variable BvpIntra[compIdx] specifies a block vector predictor. The horizontal block vector component is assigned compIdx=0 and the vertical block vector component is assigned compIdx=1. Depending upon PartMode, the variable numPartitions is derived as follows: If PartMode is equal to PART_{—}2N×2N, numPartitions is set equal to 1; otherwise, if PartMode is equal to either PART_{—}2N×N or PART_N×2N, numPartitions is set equal to 2; otherwise, (PartMode is equal to PART_N×N), numPartitions is set equal to 4.

The array of block vectors bvIntra is derived by the following ordered steps, for the variable blkIdx proceeding over the values 0 . . . (numPartitions−1): 1. The variable blkInc is set equal to (PartMode==PART_{—}2N×N ? 2:1). 2. The variable xPb is set equal to xCb+nPbSw*(blkIdx*blkInc % 2). 3. The variable yPb is set equal to yCb+nPbSh*(blkIdx/2). 4. The following ordered steps apply, for the variable compIdx proceeding over the values 0 . . . 1:5. Depending upon the number of times this process has been invoked for the current coding tree unit, the following applies: If this process is invoked for the first time for the current coding tree unit, bvIntra[xPb][yPb][compIdx] is derived as follows:

bvIntra[xPb][yPb][0]=BvdIntra[xPb][yPb][0]−nCbS (8-25)

bvIntra[xPb][yPb][1]=BvdIntra[xPb][yPb][1] (8-25)

Otherwise, bvIntra[xPb][yPb][compIdx] is derived as follows:

bvIntra[xPb][yPb][0]=BvdIntra[xPb][yPb][0]+BvpIntra[0] (8-25)

bvIntra[xPb][yPb][1]=BvdIntra[xPb][yPb][1]+BvpIntra[1] (8-25)

6. The value of BvpIntra[compIdx] is updated to be equal to bvIntra[xPb][yPb][compIdx]. 7. For use in derivation processes of variables invoked later in the decoding process, the following assignments are made for x=0 . . . nPbSw−1 and y=0 . . . nPbSh−1:

bvIntra[xPb+x][yPb+y][compIdx]=bvIntra[xPb][yPb][compIdx] (8-25)

8a. The prediction list utilization flags predFlagL0 and predFlagL1 the reference indices refIdxL0 and refIdxL1 and luma motion vectors mvL0 and mvL1 are derived as
predFlagL0[xPb][yPb]=1
predFlagL1[xPb][yPb]=0
mvL0[xPb][yPb][compIdx]=bvIntra[xPb][yPb][compIdx]<<2
mvL1[xPb][yPb][compIdx]=0
refIdxL0[xPb][yPb]=num_ref idx_{—}10_active_minus1+1 refIdxL1[xPb][yPb]=−1
   8b. Alternatively, the prediction list utilization flags predFlagL0 and predFlagL1 the reference indices refIdxL0 and refIdxL1 and luma motion vectors mvL0 and mvL1 are derived as
predFlagL0[xPb][yPb]=0
predFlagL1[xPb][yPb]=1
mvL0[xPb][yPb][compIdx]=0
mvL1[xPb][yPb][compIdx]=bvIntra[xPb][yPb][compIdx]<<2
refIdxL0[xPb][yPb]=−1
refIdxL1[xPb][yPb]=num_ref_idx_{—}11_active_minus1+1
   9. CuPredMode[xPb][yPb] is set to MODE_INTER.

It may be a requirement of bitstream conformance that all of the following conditions are true: The value of bvIntra[xPb][yPb][0] shall be greater than or equal to −(xPb % CtbSizeY+64); the value of bvIntra[xPb][yPb][1] shall be greater than or equal to −(yPb % CtbSizeY); when the derivation process for z-scan order block availability as specified in subclause 6.4.1 is invoked with (xCurr, yCurr) set equal to (xCb, yCb) and the neighboring luma location (xNbY, yNbY) set equal to (xPb+bvIntra[xPb][yPb][0], yPb+bvIntra[xPb][yPb][1]) as inputs, the output shall be equal to TRUE; when the derivation process for z-scan order block availability as specified in subclause 6.4.1 is invoked with (xCurr, yCurr) set equal to (xCb, yCb) and the neighboring luma location (xNbY, yNbY) set equal to (xPb+bvIntra[xPb][yPb][0]+nPbSw−1, yPb+bvIntra[xPb][yPb][1]+nPbSh−1) as inputs, the output shall be equal to TRUE; one or both of the following conditions shall be true: bvIntra[xPb][yPb][0]+nPbSw<=0; and bvIntra[xPb][yPb][1]+nPbSh<=0.

Inputs to the process of decoding intra blocks include: A sample location (xTb0, yTb0) specifying the top-left sample of the current transform block relative to the top left sample of the current picture; a variable log 2TrafoSize specifying the size of the current transform block; a variable trafoDepth specifying the hierarchy depth of the current block relative to the coding unit; a variable predModeIntra specifying the intra prediction mode; a variable predModeIntraBc specifying the intra block copying mode; a variable bvIntra specifying the intra block copying vector; and a variable cIdx specifying the colour component of the current block. An output of this process includes a modified reconstructed picture before deblocking filtering.

The luma sample location (xTbY, yTbY) specifying the top-left sample of the current luma transform block relative to the top-left luma sample of the current picture is derived as follows:

(xTbY,yTbY)=(cIdx==0)?(xTb0,yTb0):(xTb0*SubWidthC,yTb0*SubHeightC) (8-26)

The variable splitFlag is derived as follows: If cIdx is equal to 0, splitFlag is set equal to split_transform_flag[xTbY][yTbY][trafoDepth]; otherwise, if all of the following conditions are true, splitFlag is set equal to 1: cIdx is greater than 0; split_transform_flag[xTbY][yTbY][trafoDepth] is equal to 1; and log 2TrafoSize is greater than 2; otherwise, splitFlag is set equal to 0.

Depending on the value of splitFlag, the following applies: If splitFlag is equal to 1, the following ordered steps apply: 1. The variables xTb1 and yTb1 are derived as follows: If either cIdx is equal to 0 or ChromaArrayType is not equal to 2, the following applies: The variable xTb1 is set equal to xTb0+(1<<(log 2TrafoSize−1)), and the variable yTb1 is set equal to yTb0+(1<<(log 2TrafoSize−1)); otherwise, (ChromaArrayType is equal to 2 and cIdx is greater than 0), the following applies: The variable xTb1 is set equal to xTb0+(1<<(log 2TrafoSize−1)), and the variable yTb1 is set equal to yTb0+(2<<(log 2TrafoSize−1)). 2. The general decoding process for intra blocks as specified in this subclause is invoked with the location (xTb0, yTb0), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering. 3. The general decoding process for intra blocks as specified in this subclause is invoked with the location (xTb1, yTb0), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering. 4. The general decoding process for intra blocks as specified in this subclause is invoked with the location (xTb0, yTb1), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering. 5. The general decoding process for intra blocks as specified in this subclause is invoked with the location (xTb1, yTb1), the variable log 2TrafoSize set equal to log 2TrafoSize−1, the variable trafoDepth set equal to trafoDepth+1, the intra prediction mode predModeIntra, and the variable cIdx as inputs, and the output is a modified reconstructed picture before deblocking filtering.

Otherwise (splitFlag is equal to 0), for the variable blkIdx proceeding over the values 0 . . . (cIdx>0 && ChromaArrayType==2 ? 1:0), the following ordered steps apply: 1. The variable nTbS is set equal to 1<<log 2TrafoSize. 2. The variable yTbOffset is set equal to blkIdx*nTbS. 3. The variable yTbOffsetY is set equal to yTbOffset*SubHeightC. 4. The variable residualDpcm is derived as follows: If all of the following conditions are true, residualDpcm is set equal to 1: implicit_rdpcm_enabled_flag is equal to 1, either transform_skip_flag[xTbY][yTbY+yTbOffsetY][cIdx] is equal to 1 or cu_transquant_bypass flag is equal to 1, and either predModeIntra is equal to 10 or predModeIntra is equal to 26; otherwise, residualDpcm is set equal to explicit_rdpcm_flag[xTbY][yTbY+yTbOffsetY][cIdx]. 5. Depending upon the value of predModeIntraBc, the following applies: When predModeIntraBc is equal to 0, the general intra sample prediction process as specified in subclause 8.4.4.2.1 is invoked with the transform block location (xTb0, yTb0+yTbOffset), the intra prediction mode predModeIntra, the transform block size nTbS, and the variable cIdx as inputs, and the output is an (nTbS)x(nTbS) array predSamples; otherwise (predModeIntraBc is equal to 1), the intra block copying process as specified in subclause 8.4.5.2.7 is invoked with the transform block location (xTb0, yTb0+yTbOffset), the transform block size nTbS, the variable trafoDepth, the variable bvIntra, and the variable cIdx as inputs, and the output is an (nTbS)x(nTbS) array predSamples. 6. The scaling and transformation process as specified in subclause 8.6.2 is invoked with the luma location (xTbY, yTbY+yTbOffsetY), the variable trafoDepth, the variable cIdx, and the transform size trafoSize set equal to nTbS as inputs, and the output is an (nTbS)x(nTbS) array resSamples. 7. When residualDpcm is equal to 1, depending upon the value of predModeIntraBc, the following applies: When predModeIntraBc is equal to 0, the directional residual modification process for blocks using a transform bypass as specified in subclause 8.6.5 is invoked with the variable mDir set equal to predModeIntra/26, the variable nTbS, and the (nTbS)x(nTbS) array r set equal to the array resSamples as inputs, and the output is a modified (nTbS)x(nTbS) array resamples; otherwise, (predModeIntraBc is equal to 1), the directional residual modification process for blocks using a transform bypass as specified in subclause 8.6.5 is invoked with the variable mDir set equal to explicit_rdpcm_dir_flag[xCb+xB0 xTbY][yCb+yB0 yTbY+yTbOffsetY][cIdx], the variable nTbS, and the (nTbS)x(nTbS) array r set equal to the array resSamples as inputs, and the output is a modified (nTbS)x(nTbS) array resSamples. 8. When cross_component_prediction_enabled_flag is equal to 1, ChromaArrayType is equal to 3, and cIdx is not equal to 0, the residual modification process for transform blocks using cross-component prediction as specified in subclause 8.6.6 is invoked with the current luma transform block location (xTbY, yTbY), the variable nTbS, the variable cIdx, the (nTbS)x(nTbS) array rY set equal to the corresponding luma residual sample array resSamples of the current transform block, and the (nTbS)x(nTbS) array r set equal to the array resSamples as inputs, and the output is a modified (nTbS)x(nTbS) array resSamples. 9. The picture reconstruction process prior to in-loop filtering for a colour component as specified in subclause 8.6.6 is invoked with the transform block location (xTb0, yTb0+yTbOffset), the variables nCurrSw and nCurrSh both set equal to nTbS, the variable cIdx, the (nTbS)x(nTbS) array predSamples, and the (nTbS)x(nTbS) array resSamples as inputs.

For the specification of intra block copying prediction mode, inputs to the process include a sample location (xTb0Cmp, yTb0Cmp) specifying the top-left sample of the current transform block relative to the top left sample of the current picture, a variable nTbS specifying the transform block size, a variable trafoDepth specifying the hierarchy depth of the current block relative to the coding unit, a variable bvIntra specifying the block copying vector, and a variable cIdx specifying the colour component of the current block. Output of this process include the predicted samples predSamples[x][y], with x, y=0 . . . nTbS−1.

The luma sample location (xTbY, yTbY) specifying the top-left sample of the current luma transform block relative to the top-left luma sample of the current picture is derived as follows:

(xTbY,yTbY)=(cIdx==0)?(xTb0,yTb0):(xTb0*SubWidthC,yTb0*SubHeightC) (8-62)

Depending upon the values of trafoDepth, PartMode and nTbS, the following applies: If trafoDepth is equal to 0, PartMode is not equal to PART_{—}2N×2N, and nTbS is greater than 4, the following applies, for the variable tempIdx proceeding over the values 0 . . . 3: The variable nTbS1 is set equal to nTbS/2; the variable xTb1 is set equal to xTb0+nTbS1*(blkIdx % 2); the variable yTb1 is set equal to yTb0+nTbS1*(blkIdx/2); and the general intra block copying process as specified in this subclause is invoked with the location (xTb1, yTb1), the variable nTbS set equal to nTbS1, the variable bvIntra, the variable trafoDepth is set equal to 1, and the variable cIdx as inputs, and the output is an (nTbS1)×(nTbS1) array tempSamples, and then copied into predSamples.

Otherwise, the variable by representing the block vector for prediction in full-sample units is derived as follows: If cIdx is not equal to 0, trafoDepth is equal to 0, and nTbS is equal to 4, the following applies: If ChromaArrayType is equal to 1, by is set equal to bvIntra[xTbY+4][yTbY+4], and the bitstream shall not contain data such that the value of bvIntra[xTbY+4][yTbY+4] is invalid when used as the value of bvIntra[xTbY][yTbY], where validity is defined by the bitstream conformance requirements specified in subclause 8.4.4; otherwise, if ChromaArrayType is equal to 2, by is set equal to bvIntra[xTbY+4][yTbY], and the bitstream shall not contain data such that the value of bvIntra[xTbY+4][yTbY] is invalid when used as the value of bvIntra[xTbY][yTbY], where validity is defined by the bitstream conformance requirements specified in subclause 8.4.4; otherwise, the following applies:

bv[0]=bvIntra[xTbY][yTbY][0]>>(((cIdx==0)?1:SubWidthC)−1) (8-6327)

bv[1]=bvIntra[xTbY][yTbY][1]>>(((cIdx==0)?1:SubHeightC)−1) (8-6427)

The (nTbS)x(nTbS) array of predicted samples, with x, y=0 . . . nTbS−1, are is derived as follows: The reference sample location (xRefCmp, yRefCmp) is specified by:

(xRefCmp,yRefCmp)=(xTbCmp+x+bv[0],yTbCmp+y+bv[1]) (8-6527)

Each sample at the location (xRefCmp, yRefCmp) is assigned to predSamples[x][y].

Certain aspects of this disclosure have been described with respect to the developing HEVC standard for purposes of illustration. However, the techniques described in this disclosure may be useful for other video coding processes, including other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding, as applicable.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques may be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method of decoding video data, the method comprising:
decoding a first video block in a first picture, wherein decoding the first video block includes predicting values of the first video block based on a previously decoded video block in a second picture, wherein the second picture is different than the first picture;
filtering the first video block according to a deblocking filtering process;
decoding a second video block in the first picture, wherein decoding the second video block includes predicting values of the second video block based on a previously decoded video block in the first picture; and
filtering the second video block according to the deblocking filtering process.

2. The method of claim 1, further comprising setting a reference index for the second video block to a value such that the reference index indicates that the second video block in the first picture is predicted based on the previously decoded video block in the first picture.

3. The method of claim 1, further comprising determining a block vector, wherein the block vector comprises a motion vector between the second video block in the first picture and the previously decoded video block in the first picture.

4. The method of claim 1, further comprising:
decoding a third video block in the first picture, wherein decoding the third video block includes predicting values of the third video block based on a previously decoded video block in the first picture and a previously decoded video block in a third picture, wherein the third picture is different than the first picture; and
filtering the third video block according to the deblocking filtering process.

5. The method of claim 4, wherein the third video block is a bi-directional predictive block.

6. The method of claim 1, further comprising:
decoding a third video block in the first picture, wherein decoding the third video block includes predicting values of the third video block in the first picture based on a second previously decoded video block in the first picture, and wherein the second previously decoded video block in the first picture was decoded based on a third previously decoded video block in the first picture and an Intra coding mode;
filtering the third video block according to a second deblocking filtering process.

7. The method of claim 1, wherein the previously decoded block in the first picture was decoded based on a previously decoded block in a third picture, wherein the third picture is different than the first picture.

8. A device for decoding video data, the device comprising:
a memory configured to store the video data; and
one or more processors configured to:
decode a first video block in a first picture, wherein decoding the first video block includes predicting values of the first video block based on a previously decoded video block in a second picture, wherein the second picture is different than the first picture;
filter the first video block according to a deblocking filtering process;
decode a second video block in the first picture, wherein decoding the second video block includes predicting values of the second video block based on a previously decoded video block in the first picture; and
filter the second video block according to the deblocking filtering process.

9. The device of claim 8, wherein the one or more processors are further configured to set a reference index for the second video block to a value such that the reference index indicates that the second video block in the first picture is predicted based on the previously decoded video block in the first picture.

10. The device of claim 8, wherein the one or more processors are further configured to determine a block vector, wherein the block vector comprises a motion vector between the second video block in the first picture and the previously decoded video block in the first picture.

11. The device of claim 8, wherein the one or more processors are further configured to:
decoding a third video block in the first picture, wherein decoding the third video block includes predicting values of the third video block based on a previously decoded video block in the first picture and a previously decoded video block in a third picture, wherein the third picture is different than the first picture; and
filtering the third video block according to the deblocking filtering process.

12. The device of claim 11, wherein the third video block is a bi-directional predictive block.

13. The device of claim 8, wherein the one or more processors are further configured to:
decoding a third video block in the first picture, wherein decoding the third video block includes predicting values of the third video block in the first picture based on a second previously decoded video block in the first picture, and wherein the second previously decoded video block in the first picture was decoded based on a third previously decoded video block in the first picture and an Intra coding mode;
filtering the third video block according to a second deblocking filtering process.

14. The device of claim 8, wherein the previously decoded block in the first picture was decoded based on a previously decoded block in a third picture, wherein the third picture is different than the first picture.

15. The device of claim 8, wherein the device comprises at least one of:
an integrated circuit;
a microprocessor; or
a wireless communication device.

16. The device of claim 8, further comprising a display configured to display decoded pictures of the video data.

17. A computer-readable storage medium encoded with instructions that, when executed, cause one or more processors to:
decode a first video block in a first picture, wherein decoding the first video block includes predicting values of the first video block based on a previously decoded video block in a second picture, wherein the second picture is different than the first picture;
filter the first video block according to a deblocking filtering process;
decode a second video block in the first picture, wherein decoding the second video block includes predicting values of the second video block based on a previously decoded video block in the first picture; and
filter the second video block according to the deblocking filtering process.

18. The computer-readable storage medium of claim 17, further comprising setting a reference index for the second video block to a value such that the reference index indicates that the second video block in the first picture is predicted based on the previously decoded video block in the first picture.

19. The computer-readable storage medium of claim 17, further comprising determining a block vector, wherein the block vector comprises a motion vector between the second video block in the first picture and the previously decoded video block in the first picture.

20. The computer-readable storage medium of claim 17, further comprising:
decoding a third video block in the first picture, wherein decoding the third video block includes predicting values of the third video block based on a previously decoded video block in the first picture and a previously decoded video block in a third picture, wherein the third picture is different than the first picture; and
filtering the third video block according to the deblocking filtering process.

21. The computer-readable storage medium of claim 20, wherein the third video block is a bi-directional predictive block.

22. The computer-readable storage medium of claim 17, further comprising:
decoding a third video block in the first picture, wherein decoding the third video block includes predicting values of the third video block in the first picture based on a second previously decoded video block in the first picture, and wherein the second previously decoded video block in the first picture was decoded based on a third previously decoded video block in the first picture and an Intra coding mode;
filtering the third video block according to a second deblocking filtering process.

23. The computer-readable storage medium of claim 17, wherein the previously decoded block in the first picture was decoded based on a previously decoded block in a third picture, wherein the third picture is different than the first picture.

24. A method of encoding video data, the method comprising:
encoding a first video block in a first picture, wherein encoding the first video block includes predicting values of the first video block based on a previously encoded video block in a second picture, wherein the second picture is different than the first picture;
filtering the first video block according to a deblocking filtering process;
encoding a second video block in the first picture, wherein encoding the second video block includes predicting values of the second video block based on a previously encoded video block in the first picture; and
filtering the second video block according to the deblocking filtering process.

25. The method of claim 24, further comprising setting a reference index for the second video block to a value such that the reference index indicates that the second video block in the first picture is predicted based on the previously encoded video block in the first picture.

26. The method of claim 24, further comprising determining a block vector, wherein the block vector comprises a motion vector between the second video block in the first picture and the previously encoded video block in the first picture.

27. The method of claim 24, further comprising:
encoding a third video block in the first picture, wherein encoding the third video block includes predicting values of the third video block based on a previously encoded video block in the first picture and a previously encoded video block in a third picture, wherein the third picture is different than the first picture; and
filtering the third video block according to the deblocking filtering process.

28. The method of claim 27, wherein the third video block is a bi-directional predictive block.

29. The method of claim 24, further comprising:
encoding a third video block in the first picture, wherein encoding the third video block includes predicting values of the third video block in the first picture based on a second previously encoded video block in the first picture, and wherein the second previously encoded video block in the first picture was encoded based on a third previously encoded video block in the first picture and an Intra coding mode;
filtering the third video block according to a second deblocking filtering process.

30. The method of claim 24, wherein the previously encoded block in the first picture was encoded based on a previously encoded block in a third picture, wherein the third picture is different than the first picture.
